(19) United States
(12) Patent Application Publication
(10) Pub. No.: US 2014/0135297 A1
(43) Pub. Date: May 15, 2014

(54) AQUEOUS VOLATILE ORGANIC COMPOUND FREE DISINFECTANT AND/OR CLEANING COMPOSITION AND METHOD OF PREPARATION

(71) Applicants: Kolazi S Narayanan, Wayne, NJ (US); Domingo Jon, New York, NY (US); Patel V. Jayanti, Elmwood Park, NJ (US); Liu Xuejun, Whippany, NJ (US); Karen Winkowski, Springfield, NJ (US); Raman Premachandran, Saddle Brook, NJ (US); Lindstrom Susan, Ramsey, NJ (US)

(72) Inventors: Kolazi S Narayanan, Wayne, NJ (US); Domingo Jon, New York, NY (US); Patel V. Jayanti, Elmwood Park, NJ (US); Liu Xuejun, Whippany, NJ (US); Karen Winkowski, Springfield, NJ (US); Raman Premachandran, Saddle Brook, NJ (US); Lindstrom Susan, Ramsey, NJ (US)

(73) Assignee: ISP Investments Inc., Wilmington, DE (US)

(21) Appl. No.: 14/125,115

(22) PCT Filed: Jun. 8, 2012
(86) PCT No.: PCT/US2012/041589

§ 371 Date: Dec. 10, 2013

Related U.S. Application Data
(60) Provisional application No. 61/495,434, filed on Jun. 10, 2011.

(51) Int. Cl. A01N 37/02; A01N 31/08; A01N 31/16

(52) U.S. Cl. CPC A01N 37/02; A01N 31/16; A01N 31/08
USPC 514/159; 514/721; 514/731; 514/558; 422/27

(57) ABSTRACT

The present application provides an aqueous, stable, VOC-free microemulsion based antimicrobial disinfectant and/or cleaning concentrate composition capable of inhibiting or killing gram(+), gram(−) and methicillin-resistant Staphylococcus aureus (MRSA) comprising (i) a water-soluble matrix composite made of (a) water-soluble polymer, and (b) water-soluble surfactant; (ii) a blend of antimicrobial agents comprising (a) at least one compound selected from phenols, halogenated phenols, derivatives of phenols, derivatives of halogenated phenols, bis -phenols, cresols, resorcinols, halogenated hydroxyl diphenylethers, anilides or combinations thereof; and (b) at least one compound derived from essential oils; and (iii) optionally, one or more additives. Also, there is described a method of use and process for preparing the composition.

### CROSS REFERENCE TO RELATED APPLICATION

This application claims benefit to U.S. Provisional Application Serial No. 61/495,434 filed on Jun. 10, 2011,the entire contents of which are hereby incorporated by reference.

### BACKGROUND OF THE INVENTION

1. Field of the Invention

The present application relates to disinfectant and/or cleaning composition and more particularly, to a volatile organic compound (VOC) free microemulsion based antimicrobial disinfectant and/or cleaning concentrate composition comprising a water-soluble matrix composite and a blend of antimicrobial agents.

2. Summary of the Invention

The elimination of pathogenic microorganism in different surfaces has been a difficult task for house-keeping professionals. In particular, the hard surfaces where these types of micro-organisms may exist for longer duration. Hard surfaces, like walls, tiles, table tops, glass as well as dishes, are susceptible to soiling and contamination with various micro-organisms like gram (+) bacterial strains and gram (−) bacterial strains, viruses, and other more resistant micro-organisms like fungi and MRSA (methicillin-resistant Staphylococcus aureus). These hard-surfaces prone to soiling and contamination with micro-organisms can be found in various locations like: private households, for example, in kitchens and bathrooms; hospitals; restaurants; hotels; means of public transport; public bathes and pools; commercial and public laundries and the like. MRSA has recognized itself as a major hospital pathogen responsible for many nosocomial infections, and is now prevalent in most hospitals. Staphylococcus infections, including MRSA infections, most frequently occur in hospitals and healthcare facilities, such as nursing homes and dialysis centers. In these institutions, individuals often have weakened immune systems and are more prone to MRSA infections. Healthcare associated MRSA infections include surgical wound infections, urinary tract infections, bloodstream infections, and pneumonia, which may require hospitalization and treatment with antibiotics.

Further, MRSA is frequently found in the environment of both colonized and infected patients and colonized health care workers. The pathogen can be transmitted by the gloves of health care providers and increases in concentration in the stool of colonized patients receiving broad spectrum antibiotics. Consequently, it is likely that environmental contamination plays a role in the spread of MRSA.

MRSA infection in hospitals is a matter of serious concern. However, the incidence of MRSA among Staphylococcus aureus strains detected in large hospitals is very large. Accordingly, the defensive measures taken today against the emergence of MRSA are essentially insufficient. Moreover, once man is infected with MRSA, antibiotic therapy cannot be an effective remedy and the risk for death is high. Vancomycin, for instance, is an antibiotic which is comparatively active against MRSA but it is certain that, being one of resistant bacteria, MRSA will acquire resistance to vancomycin, too, in the not-too-distant future.

US Publication No. 20090311136 assigned to Manning, JR. James T. et al. discloses an antibacterial cleaning composition comprising: (a) an enzyme in an amount effective to promote cleaning; (b) viable microorganisms in an amount effective to degrade and promote the degradation of organic materials; (c) a surfactant; and (d) an aqueous carrier; said cleaning composition maintaining at least 95% enzymatic activity at a pH range of from about 5.5 to about 13.5. One of the objectives of this application is to provide a method of controlling or eliminating a population of MRSA on a surface comprising applying an enzymatic cleaning composition containing viable microorganisms and having high activity at high pH.

US Publication No. 20100055196 to Ebiox Limited discloses a sanitizing composition capable of destroying pathogens present at a locus and/or of removing biofilm present at a locus (for example MRSA or Legionella) featuring an aqueous solution comprising at least one surfactant, preferably non-ionic; at least one antimicrobial agent, preferably a biguanide and/or quaternary ammonium compound; at least one acid, preferably organic; and chlorine dioxide. The sanitizing composition is formed by making two precursor compositions, one containing the chlorine dioxide stabilized in an alkaline medium, and the other containing acid. These precursor compositions are mixed to form a concentrate composition. A dwell time is allowed. Once the dwell time has elapsed the concentrate composition is diluted with water, and the resulting sanitizing composition can be used.

U.S. Pat. No. 7,578,970 assigned to Knockout Technologies, Ltd. discloses highly potent, non-toxic, disinfectant that can be used for a wide breadth of applications. The disinfectant comprises hydrogen peroxide, orange terpene oil, orange valencia oil, a non-ionic emulsifier (polysorbate 80), and water. Applications of disinfectant include, but are not limited to, uses as a mouthwash, skin cleanser, or as a germicidal for disinfecting surfaces such as foodstuff, plant matter, leather, wood, metal, plastic and fabrics. Methods for using the disinfectant composition of the invention are also provided. The disinfectant composition is capable of inhibiting Salmonella cholerasuis, Staphylococcus aureaus including Methicillin resistant Staphylococcus aureaus (MRSA), Pseudomonas aeruginosa, Escherichia coli, Streptococcus pneumonia, and Listeria monocytogenes.

PCT Publication No. WO 2008016837 assigned to ISP Investments Inc. discloses an aqueous composition containing a hydrophobic material, and, more particularly, a water soluble matrix of a water soluble polymer and a water soluble surfactant, in the form of a complex, for stabilizing the hydrophobic material, as a nanoparticulate dispersion or emulsion. The delivery system for delivering bioactive hydrophobic materials is an aqueous nanoparticle dispersion of a water soluble matrix of polymer and a surfactant.

U.S. Pat. No. 5,888,957 assigned to Colgate Palmolive Company discloses a cleaning composition consisting essentially of (a) about 3.0 wt. % to about 40 wt. % of a negatively charged complex comprising (i) at least one first surfactant which is an anionic surfactant selected from the group consisting of alkali metal salts of sulfonates, alkali metal salts of sulfates, alkaline earth metal salts of sulfonates and alkaline earth metal salts of sulfates; and (ii) a second surfactant being selected from the group consisting of a sulfonamide, glucoamides, N—C₁₋₃ alkyl C₈-C₁₆ alkyl glucoamide, and C₅-C₁₂ N-alkyl aldoamide and mixtures thereof, said second surfactant being complexed with said first surfactant; (b) about 0.5 wt. % to 15 wt. % of a co-surfactant; (c) about 0.4 wt. % to about 10 wt. % of a water insoluble organic compound, essential oil or a perfume; (d) 0.5% to 10% of a Lewis base, neutral polymer; and (e) the balance being water.

US Publication No. 20070071778 to ISP Investments Inc. discloses a stable microemulsion concentrate and composition for delivery of an active biocide/disinfectant in an aqueous medium providing sustained release of the active. The composition is effective against both bacteria and fungi. The stable microemulsion concentrate consists of, by wt. (a) 0.1-20% of a bioactive ingredient which is a halogen, triclosan, iodopropargyl butyl carbamate, a quaternary ammonium compound, an organometallic, iodophor, a nitrogen compound, an organo-sulfur compound, chloroisocyanurate, glutaraldehyde or pine oil, a fragrance or body wash, and (b) 80-99.9% of a polymeric matrix including an alkylated vinyl pyrrolidone copolymer.

U.S. Pat. No. 6,613,730 to Colgate-Palmolive Company (New York, NY) discloses a cleaning composition comprising (a) about 0.1 wt. % to about 20 wt. % of a charged surfactant-polymer complex comprising: (i) an alkali metal salt of a fluoroalkyl sulfonate anionic surfactant, or an ammonium salt of a fluoroalkyl sulfonate anionic surfactant, or mixtures thereof; and (ii) a polymer being complexed with said anionic surfactant in a molar ratio of said anionic surfactant to the highly dipolar or positively charged binding sites available on the backbone of said polymer about 0.95:1 to 0.05:1,wherein said polymer is polyvinyl pyridine betaine, and (b) the balance being water. This microemulsion composition is environmentally friendly, which is especially effective in the removal of oily or greasy soils.

U.S. Pat. No. 6,531,442 to Colgate-Palmolive Company (New York, N.Y.) discloses a cleaning composition comprising: (a) about 0.1 wt. % to about 20 wt. % of a charged surfactant-polymer complex comprising (i) an alkali metal salt of a fluoroalkyl sulfonate anionic surfactant, or an ammonium salt of a fluoroalkyl sulfonate anionic surfactant, or mixtures thereof; and (ii) a polymer being complexed with said anionic surfactant in a molar ratio of said anionic surfactant to the highly dipolar or positively charged binding sites available on the backbone of said polymer about 0.95:1 to 0.05:1,wherein said polymer is polyvinyl pyridine betaine, and (b) the balance being water.

There is a long felt need, therefore, for disinfecting and/or cleaning compositions and methods that are efficient and cost effective. Also, there is a continuing need, for aqueous, volatile organic compounds (VOC) free antimicrobial disinfecting and/or cleaning compositions for hard surfaces. Furthermore, there is a tremendous need for compositions such as the ones of the present application which are useful for disinfecting and/of cleaning hard surfaces, especially surfaces contaminated with MRSA.

Therefore, it is an objective of the present application to provide an aqueous, stable, volatile organic compound (VOC)-free microemulsion based antimicrobial disinfectant and/or cleaning concentrate composition capable of inhibiting or killing gram(+), gram(−) and Methicillin-resistant Staphylococcus aureus (MRSA).

### SUMMARY

In accordance with certain aspects, the present application provides an aqueous, stable, VOC-free microemulsion based antimicrobial disinfectant and/or cleaning concentrate composition capable of inhibiting or killing gram(+), gram(−) and methicillin-resistant Staphylococcus aureus (MRSA) comprising (i) a water-soluble matrix composite made of (a) water-soluble polymer, and (b) water-soluble surfactant; (ii) a blend of antimicrobial agents comprising (a) at least one compound selected from phenols, halogenated phenols, derivatives of phenols, derivatives of halogenated phenols, bis-phenols, cresols, resorcinols, halogenated hydroxyl diphenylethers, anilides or in combinations thereof; and (b) at least one compound derived from essential oils; and (iii) optionally, one or more additives.

The present application also describes a heat and cold stable antimicrobial disinfectant and/or cleaning concentrate composition wherein the composition is stable for at least six months at room temperature or stable for at least 3 freeze/thaw cycles wherein temperature cycled from 50° C. to −24° C. in every 24 hours or stable for at least 2 weeks at about 50° C.

In accordance with certain embodiments of the present application, the water-soluble matrix is a complex of water-soluble polymer and water-soluble surfactant having lower critical micelle concentration (cmc) than a composition without the water-soluble polymer.

According to another embodiment, the water-soluble polymer is selected from the group consisting of acid, ester, amide or salts of olefinic polymers, lactam/pyrrolidone based polymers, pyrrolidone co-polymers, α-olefin maleic acid/ester co-polymers, α-olefin polymers, carbohydrate based polymers, and natural polymers or gums alone or in combination.

Yet another embodiment of the present application features a water-soluble surfactant selected from the group consisting of sulfonates, sulfates, phosphates, phosphonates, amine oxides, ammonium carboxylates, ammonium sulfonates, polysorbates, polyalkoxylated alkanols, polyalkoxylated alkylphenols, polyalkoxylated esters, EO/PO copolymers, poloxamers, alkyl polyglucosides, naturally occuring surface active compositions, phospholipids, fatty acid based surfactants, surface active homo or copolymers of polyamines, polyimines, polyalkyleneimines, alkyl/aryl amine alkoxylates, alkyl/aryl/arylalkyl amine oxides, alkoxylated ethylene diamine derivatives alone or in combination.

In accordance with one aspect, there is provided a process for preparing a aqueous, stable, volatile organic compound (VOC)-free microemulsion based antimicrobial disinfectant and/or cleaning concentrate composition comprising the steps of (i) preparing a mixture of (a) water-soluble matrix composite and (b) a blend of antimicrobial agents; (ii) dissolving the mixture of step (i) in an suitable aqueous medium; and (iii) incorporating additives if any to the step (ii) and vigorously mixing the composition to result in stable, aqueous, homogenous, optically clear disinfectant concentrate composition.

Another aspect of the present application is to provide a method for disinfecting or cleaning of hard surfaces where the presence of gram (+), gram (−) and/or Methicillin-resistant Staphylococcus aureus (MRSA) is suspected which comprises the step of (i) diluting the concentrate composition of the present application in water in a weight ratio of concentrate:water of from 1:10 to 1:1000; (ii) contacting the hard surface with a disinfecting and/or cleaning effective amount of the concentrate composition; and (iii) applying steam of water vapor to enhance the penetration of disinfectant and/or cleaning components to result in enhanced antimicrobial efficacy.

The additive is selected from the group consisting of flavors, colors, thickeners, pH adjusting agents, pH buffers including organic and inorganic salts, fragrances, fragrance solubilizers/enhancers, insect-repellants, opacifiers, skin conditioning agents, skin protectants, anti-caking agent, abrasive agent, corrosion inhibitor, defoamer, bleaching agents, anti-spotting agents, anti-oxidants, optical brighteners, hydrotropes, light stabilizers, enzymes, preservatives, and/or sequestering/scale-inhibiting agents

### DETAILED DESCRIPTION

While this specification concludes with claims particularly pointing out and distinctly claiming that, which is regarded as the invention, it is anticipated that the invention can be more readily understood through reading the following detailed description of the invention and study of the included examples.

By the term “comprising” herein is meant that various optional, compatible components can be used in the compositions herein, provided that the important ingredients are present in the suitable form and concentrations. The term “comprising” thus encompasses and includes the more restrictive terms “consisting of” and “consisting essentially of” which can be used to characterize the essential ingredients, water, water-soluble composite made of water-soluble polymer and water-soluble surfactant, antibacterial agent, and additives if any.

All percentages, parts, proportions and ratios as used herein, are by weight of the total composition, unless otherwise specified. All such weights as they pertain to listed ingredients are based on the active level and, therefore; do not typically include solvents or by-products that may be included in commercially available materials, unless otherwise specified.

All references to singular characteristics or limitations of the present invention shall include the corresponding plural characteristic or limitation, and vice-versa, unless otherwise specified or clearly implied to the contrary by the context in which the reference is made.

Numerical ranges as used herein are intended to include every number and subset of numbers contained within that range, whether specifically disclosed or not. Further, these numerical ranges should be construed as providing support for a claim directed to any number or subset of numbers in that range.

The term “about” can indicate a variation of 10 percent of the value specified; for example about 50 percent carries a variation from 45 to 55 percent. For integer ranges, the term about can include one or two integers greater than and less than a recited integer.

The patents and publications referred to herein are hereby incorporated by reference to the extent necessary to understand the present invention.

As used herein, the words “preferred,” “preferably” and variants refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

References herein to “one embodiment,” “one aspect” or “one version” or “one objective” of the invention include one or more such embodiment, aspect, version or objective, unless the context clearly dictates otherwise.

As used herein, the term “aqueous” refers to a component that is hydrophilic and/or soluble in water. In various embodiments, the aqueous component is water in amounts of about 5% to about 95%.

The term “Volatile Organic Compounds (VOC)-free” as used herein is referring to a composition of the present application means that no external solvent constituent has been added in the present aqueous concentrate composition at any point of time and it should be understood by one of ordinary skill in the art that residual solvents may be present inherently in commercially available or synthesized products which may or may not be part of the aqueous composition of the present invention and wherein the inherent presence of residual solvent is not precluded by use of the term “Volatile Organic Compounds (VOC)-free”.

As used herein, the term “microemulsion” means an emulsion that form spontaneously and has a droplet size comprises of about 5 to 200 nm According to a particular embodiment of this specification, the present microemulsion has a droplet size is from about 10 to 90 nm, or even about 10 to 60 nm

As used herein, the term “disinfectant” means an agent that destroys or inhibits pathogens capable of replication and capable of causing diseases in humans, animals, or plants. Examples of such pathogens include, but are not limited to, bacteria, spores, fungi, cells, viruses, DNA, biologically active substances, and prions.

As used herein, the term “polymer” is meant to encompass oligomer, and includes, without limitation, homopolymers, copolymers, terpolymers, etc. The polymers described herein can also be linear, branched and/or crosslinked polymers.

As used herein, the term “water-soluble,” when used in relation to polymers and polymer complexes, refers to polymers and polymer complexes that form a solution in water that is free of insoluble polymer particles. The determination that a solution is free of insoluble polymer particles can be made using conventional light scattering techniques or by passing the solution through a sufficiently fine filter screen capable of capturing insoluble polymer particles. As a non-limiting example, an aqueous solution containing 5 percent by weight of a polymer can be prepared and poured through a U.S. Standard Sieve No. 100 (150 μ), and no particles are left on the screen. Alternatively, the turbidity of an aqueous solution containing 2.5 percent by weight of a polymer at a pH of from 5-9, may be measured using a turbidimeter or nephelometer. A reading of less than 20 nephelometric turbidity units (NTU) indicates the water-solubility of the polymer or polymer complex.

As used herein, the term “antimicrobial agent” refers to an antimicrobial agent/s isolated from essential oils and/or their semi-synthetic derivatives, essential oils, synthetic antimicrobial agents such as phenols, halogenated phenols, derivatives of phenols, derivatives of halogenated phenols, bis-phenols, cresols, resorcinols, halogenated hydroxyl diphenylethers, anilides, plant extracts or their bioactive fractions, naturally available disinfecting plant products alone or in combination.

Disclosed herein is an aqueous, stable, VOC-free microemulsion based antimicrobial disinfectant and/or cleaning concentrate composition capable of inhibiting or killing gram(+), gram(−) and Methicillin-resistant Staphylococcus aureus (MRSA) comprising (i) a water-soluble matrix composite made of (a) water-soluble polymer, and (b) water-soluble surfactant; (ii) a blend of antimicrobial agents comprising (a) at least one compound selected from phenols, halogenated phenols, derivatives of phenols, derivatives of halogenated phenols, bis-phenols, cresols, resorcinols, halogenated hydroxyl diphenylethers, anilides or in combinations thereof; and (b) at least one compound derived from essential oils; and (iii) optionally, one or more additives.

In accordance with particular embodiments, the compositions include a water soluble matrix of a water soluble polymer and a water soluble surfactant. The matrix is in the form of a complex that stabilizes the blend of antimicrobial agent present in the composition as a micro-emulsion wherein the antimicrobial agent is present as particles in the micro/nanoparticle range. In accordance with certain embodiments of the present invention, the compositions exhibit visual clarity and can be diluted to form use compositions of various concentrations of the antimicrobial agent. The term “complex” is used broadly to refer to a surfactant-polymer combination wherein the surfactant and polymer interact to provide a lower surface tension than either one of the components alone. Although not wishing to be bound by theory, it is theorized that the polymer-surfactant complex functions to stabilize the blend of hydrophobic antimicrobial agents in the present composition.

Aqueous compositions containing a hydrophobic material, and, more particularly, a water soluble matrix of a water soluble polymer and a water soluble surfactant in the form of a complex are described in U.S. patent application Ser. No. 11/496,599, filed Jul. 31,2006, U.S. patent application Ser. No. 11/803,108, filed May 11,2007, and International Publication No. WO2008/016837, filed Jul. 27, 2007, the contents of which are hereby incorporated by reference.

Water-soluble polymers useful in the present application include those capable of forming a complex with a water-soluble surfactant wherein the complex facilitates formation of a micro/nanoemulsion or micro/nanodispersion of the water-insoluble or water-immiscible antimicrobial ingredients present in the composition. Examples of typical polymer species include, but are not limited to the following categories, i.e. Lactam/Pyrrolidone based polymers, Polyvinyl pyrrolidone/polyvinyl caprolactam, Pyrrolidone co-polymers, Vinyl acetate-Vinylpyrrolidone co-polymers, Alkylated graft Vinylpyrrolidone co-polymers, Dimethylaminoethylmethacrylate Vinylpyrrolidone co-polymers, Acrylic acid/Acrylic ester/ Acrylic salt—Vinylpyrrolidone co-polymers, Vinylpyrrolidone/Vinyl caprolactam co-polymers, Alpha olefin maleic acid/ester co-polymers, Styrene maleic acid co-polymers, Alkyl vinyl ether-maleic acid/ester/salts co-polymers, Alpha olefin Polymers: Polyacrylates/polyvinyl derivatives, Poly alkylacrylate/alkylacrylic esters/amides/salts, Polyvinyl alcohol/acetates, Natural polymers, Cellulosic derivatives, Modified Starch and/or alginates.

The water-soluble polymer employed in an amount sufficient to form a complex with the water-soluble surfactant and interact with the surfactant to lower the cmc of the system as compared to a system without the polymer. For certain embodiments, the water-soluble polymer will be present in an amount by weight percent of about 0.001% to about 40%, more particularly from about 0.01% to about 30% and in accordance with certain embodiments from about 0.01% to about 20% of the concentrate. For use compositions, the water soluble polymer will typically be present in an amount by weight of about 1 ppm to about 10,000 ppm, more particularly from about 2 ppm to about 5,000 ppm and in accordance with certain embodiments from about 5 ppm to about 4,000 ppm of the diluted use composition.

Suitable surfactant for preparing disinfectant and/or cleaning composition may be selected from anionic, non-ionic, amphoteric, cationic and mixtures thereof. The contemplated list of surfactants for the present application is as follows:

(A) Anionic Surfactants: Anionic surfactants are particularly useful in accordance with certain embodiments of the present invention. Surfactants of the anionic type that may be useful include:

(1) Sulfonates and Sulfates: Suitable anionic surfactants include sulfonates and sulfates such as alkyl sulfates, alkylether sulfates, alkyl sulfonates, alkylether sulfonates, alkylbenzene sufonates, alkylbenzene ether sulfates, alkylsulfoacetates, secondary alkane sulfonates, secondary alkylsulfates, alkyl sulfosuccinates and the like. Further, examples of anionic surfactants include water-soluble salts of higher fatty acid monoglyceride monosulfates, such as the sodium salt of the monosulfated monoglyceride of hydrogenated coconut oil fatty acids, higher alkyl sulfates such as sodium lauryl sulfate, alkyl aryl sulfonates such as sodium dodecyl benzene sulfonate, higher alkyl sulfoacetates, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and the like.

(2) Examples include, but are not limited to: alkyl ether sulfonates such as lauryl ether sulfates such as POLYSTEP B 12 (n=3 4, M=sodium) and B22 (n=12, M=ammonium) available from Stepan Company, Northfield, 111. and sodium methyl taurate (available under the trade designation NIKKOL CMT30 from Nikko Chemicals Co., Tokyo, Japan); secondary alkane sulfonates such as Hostapur SAS which is a Sodium (C 14 C17)secondary alkane sulfonates (alpha-olefin sulfonates) available from Clariant Corp., Charlotte, N.C.; methyl-2-sulfoalkyl esters such as sodium methyl-2-sulfo(C12 16)ester and disodium 2-sulfo(C12 C16)fatty acid available from Stepan Company under the trade designation ALPHASTE PC-48; alkylsulfoacetates and alkylsulfosuccinates available as sodium laurylsulfoacetate (under the trade designation LANTHANOL LAL) and disodiumlaurethsulfosuccinate (STEPANMILD SL3), both from Stepan Company; alkylsulfates such as ammoniumlauryl sulfate commercially available under the trade designation STEPANOL AM from Stepan Company.

(3) Phosphates and Phosponates: Suitable anionic surfactants also include phosphates such as alkyl phosphates, alkylether phosphates, aralkylphosphates, and aralkylether phosphates. Examples include a mixture of mono-, di- and tri-(alkyltetraglycolether)-o-phosphoric acid esters generally referred to as trilaureth-4-phosphate commercially available under the trade designation HOSTAPHAT 340KL from Clariant Corp., as well as PPG-5 ceteth 10 phosphate available under the trade designation CRODAPHOS SG from Croda Inc., Parsipanny, N.J.

(4) Amine Oxides: Suitable anionic surfactants also include amine oxides. Examples of amine oxide surfactants include those commercially available under the trade designations AMMONYX LO, LMDO, and CO, which are lauryldimethylamine oxide, laurylamidopropyldimethylamine oxide, and cetyl amine oxide, all from Stepan Company.

(B) Amphoteric Surfactants: Surfactants of the amphoteric type include surfactants having tertiary amine groups which may be protonated as well as quaternary amine containing zwitterionic surfactants. Those that may be useful include:

(1) Ammonium Carboxylate Amphoterics: Examples of such amphoteric surfactants include, but are not limited to: certain betaines such as cocobetaine and cocamidopropyl betaine (commercially available under the trade designations MACKAM CB-35 and MACKAM L from Mclntyre Group Ltd., University Park, III); monoacetates such as sodium lauroamphoacetate; diacetates such as disodium lauroamphoacetate; amino- and alkylamino-propionates such as lauraminopropionic acid (commercially available under the trade designations MACKAM IL, MACKAM 2L, and MACKAM 151L, respectively, from Mclntyre Group Ltd.).

(2) Ammonium Sulfonate Amphoterics: This class of amphoteric surfactants are often referred to as “sultaines” or “sulfobetaines”. Examples include cocamidopropylhydroxysultaine (commercially available as MACKAM 50-SB from Mclntyre Group Ltd.).

(C) Nonionic Surfactants: Surfactants of the nonionic type that may be particularly useful include:

(1) Polyethylene oxide extended sorbitan monoalkylates (i.e., Polysorbates).

(2) Polyalkoxylated alkanols. Surfactants such as those commercially available under the trade designation BRIJ from ICI Specialty Chemicals, Wilmington, Del. having an HLB of at least about 14 may be useful.

(3) Polyalkoxylated alkylphenols. Examples of surfactants of this type include polyethoxylated octyl or nonyl phenols having HLB values of at least about 14, which are commercially available under the trade designations ICONOL and TRITON, from BASF Corp., Performance Chemicals Div., Mt. Olive, N.J. and Union Carbide Corp., Danbury, Conn., respectively. Examples include TRITON X100 (an octyl phenol having 15 moles of ethylene oxide available from Union Carbide Corp., Danbury, Conn.) and ICONOL NP70 and NP40 (nonyl phenol having 40 and 70 moles of ethylene oxide units, respectively, available from BASF Corp., Performance Chemicals Div., Mt. Olive, N.J.). Sulfated and phosphated derivatives of these surfactants may also be useful. Examples of such derivatives include ammonium nonoxynol-4-sulfate, which is commercially available under the trade designation RHODAPEX CO-436 from Rhodia, Dayton, N.J.

(4) Polaxamers. Surfactants based on block copolymers of ethylene oxide (EO) and propylene oxide (PO) may also be effective. Both EO-PO-EO blocks and PO-EO-PO blocks are expected to work well as long as the HLB is at least about 14, and preferably at least about 16. Such surfactants are commercially available under the trade designations PLURONIC and TETRONIC from BASF Corp., Performance Chemicals Div., Mt. Olive, N.J. It is noted that the PLURONIC surfactants from BASF have reported HLB values that are calculated differently than described above. In such situation, the HLB values reported by BASF should be used. For example, preferred PLURONIC surfactants are L-64 and F-127, which have HLBs of 15 and 22, respectively.

(5) Polyalkoxylated esters. Polyalkoxylated glycols such as ethylene glycol, propylene glycol, glycerol, and the like may be partially or completely esterified, i.e., one or more alcohols may be esterified, with a (C₈ to C₂₂) alkyl carboxylic acid. Such polyethoxylated esters having an HLB of at least about 14, and preferably at least about 16, may be suitable for use in compositions of the present invention.

(6) Alkyl Polyglucosides. Alkyl polyglucosides may also be used. Examples include glucopon 425, which has a (C₈ to C₁₆) alkyl chain length with an average chain length of 10.3 carbons and 14 glucose units.

(D) Cationic Surfactants: Surfactants of the cationic type that may be useful include but are not limited to primary amines, secondary amines, tertiary amines, quaternary amines, alkanolamines, mono-alkyl alkanolamines, di-alkyl alkanolamines, tri-alkyl alkanolamines, alkyl mono alkanolamines, alkyl di-alkanolamines, alkylamines, mono-alkyl amines, di-alkyl amines, tri-alkylamines, alkoxylated amines, alkyl and aryl amine alkoxylates, methoxylated alkylamines, ethoxylated alkylamines, alkoxylated alkanolamines, alkyl alkanolamines, alkoxylated ethylene diamine derivatives, alkyl/aryl/arylalkyl amine oxides. The preferred cationic surfactants of the present invention would include but are not limited to (a) alkyl alkanolamines; and (b) alkyl tertiary amines Additional information on useful cationic surfactants for the purpose of present invention is well described in McCutcheon's Detergents and Emulsifiers, North American Ed., 1982 and Kirk-Othmer, Encyclopedia of Chemical Technology, 3^{rd} Ed., Vol. 22, pp. 346-387, the contents of which are included herein by reference.

If desired, combinations of various surfactants can be used for the preparation of an aqueous, stable, VOC-free microemulsion based antimicrobial disinfectant and/or cleaning composition. Particularly the preferred anionic surfactants include alkyl esters of inorganic or organic acids with or without polyalkoxylated group included. These include the sulfonates, sulfates, phosphates, and phosphonates.

The amount of surfactant to form a microemulsion of blend of antimicrobial agents in an aqueous medium is depends on the type/s of antimicrobial agent engaged and the concentration of the antimicrobial agents and wherein, the higher the antimicrobial agent concentration, the higher the amount of surfactant to be added.

According to one embodiment of the present application, a blend of antimicrobial agents is employed to prepare disinfectant and/or cleaning composition to eradicate the microorganisms. The antimicrobial blend comprises of (a) phenols, halogenated phenols, derivatives of phenols, derivatives of halogenated phenols, bis-phenols, cresols, resorcinols, halogenated hydroxyl diphenylethers, anilides or mixtures thereof and (b) one or more compound isolated from essential oils and/or their semi-synthetic derivatives.

The contemplated list of antimicrobial agents useful for preparing microemulsion based antimicrobial disinfectant and/or cleaning composition comprising:

Phenols: Exemplary phenolic compounds of the present application would include phenol, 2-methyl phenol, 3-methyl phenol, 4-methyl phenol, 4-ethyl phenol, p-nitrophenol, 2, 4-dimethyl phenol, 2, 5-dimethyl phenol, 3, 4-dimethyl phenol, 2, 6-dimethyl phenol, 4-n-propyl phenol, 4-n-butyl phenol, 4-n-amyl phenol, 4-tert-amyl phenol, 4-n-hexyl phenol, 4-n-heptyl phenol, 5-methyl-2-pentylphenol, 4-isopropyl-3-methylphenol, cresols, m-cresol, o-cresol, p-cresol, o-phenyl-phenol, 4-chloro-m-cresol, chloroxylenol, 6-n-amyl-m-cresol, 2,6-di-tert-butyl-p-cresol.

Halogenated Phenols and derivatives: p-Chlorophenol, methyl-p-chlorophenol, ethyl-p-chlorophenol, n-propyl p-chlorophenol, n-butyl p-chlorophenol, n-amyl p-chlorophenol, sec-amyl-p-chlorophenol, n-hexyl-p-chlorophenol, cyclohexyl-p-chlorophenol, n-heptyl p-chlorophenol, n-octyl p-chlorophenol, o-chlorophenol, methyl-o-chlorophenol, ethyl-o-chlorophenol, n-propyl o-chlorophenol, n-butyl-o-chlorophenol, n-amyl-o-chlorophenol, tert-amyl-o-chlorophenol, n-hexyl-o-chlorophenol, n-heptyl-o-chlorophenol, o-benzyl-p-chlorophenol, o-benzyl-m-methyl-p-chlorophenol, o-benzyl-m, m-dimethyl-p-chlorophenol, o-phenylethyl p-chlorophenol, o-phenylethyl-m-methyl-p-chlorophenol, 3-methyl-p-chlorophenol, 3,5-dimethyl-p-chlorophenol, 6-ethyl-3-methyl-p-chlorophenol, 6-n-propyl-3-methyl-p-chlorophenol, 6-iso-propyl-3-methyl-p-chlorophenol, 2-ethyl-3,5-dimethyl-p-chlorophenol, 6-sec-butyl-3-methyl-p-chlorophenol, 2-iso-propyl-3,5-dimethyl-p-chlorophenol, 6-diethylmethyl-3-methyl-p-chlorophenol, 6-iso-propyl-2-ethyl-3-methyl-p-chlorophenol, 2-sec-amyl-3,5-dimethyl-p-chlorophenol, 2-diethylmethyl-3,5-dimethyl p-chlorophenol, 6-sec-octyl-3-methyl-p-chlorophenol, o-benzylphenol, p-chloro-o-benzylphenol, p-bromophenol, methyl-p-bromophenol, ethyl-p-bromophenol, n-propyl-p-bromophenol, n-butyl-p-bromophenol, n-amyl-p-bromophenol, sec-amyl-p-bromophenol, n-hexyl-p-bromophenol, cyclohexyl-p-bromophenol, o-bromophenol, tert-amyl-o-bromophenol, n-hexyl-o-bromophenol, n-propyl-m, m-dimethyl-o-bromophenol, 2-phenyl phenol, 4-chloro-2-methyl phenol, 4-chloro-3-methyl phenol, 4-chloro-3,5-dimethyl phenol, 2,4-dichloro-3,5-dimethylphenol, 3,4,5, 6-terabromo-2-methylphenol, p-chloro-m-xylenol, chlorothymol, and/or 5-chloro-2-hydroxydiphenylmethane.

Halogenated Diphenylethers: Polyhalogenated hydroxyl diphenyl ethers, 2′, 4,4′-trichloro-2-hydroxy-diphenyl ether (triclosan), 3-chloro-2-(2,4-dichlorophenoxy)phenol), 2′, 4,4′,5-tetrachloro-2-hydroxydiphenylether, 4,4′,5-trichloro-2-hydroxydiphenylether, 2′, 4,4′-trichloro-5-bromo-2-hydroxydiphenylether, 4,4′-dichloro-5-bromo-2-hydroxydiphenylether, 2′, 4,4′-trichloro-2-hydroxydiphenylether, 4,4′-dichloro-2-hydroxydiphenylether, 4,4′-dibromo-2-hydroxydiphenylether, 4′-methyl-4-chloro-2-hydroxydiphenylether, 2′, 4,4′,5′-tetrachloro-2-hydroxydiphenylether, 4,4′-dichloro-3′-trifluoromethyl-2-hydroxydiphenylether, 4,4′-dichloro-3′-methyl-2-hydroxydiphenylether, 4′-methoxy-4-chloro-2-hydroxydiphenylether, and/or 4,4′-dichloro-2′-cyano-2-hydroxydiphenylether.

Resorcinol and its derivatives: Resorcinol, methyl resorcinol, ethyl resorcinol, n-propyl resorcinol, n-butyl resorcinol, n-amyl resorcinol, n-hexyl resorcinol, n-heptyl resorcinol, n-octyl resorcinol, n-nonyl resorcinol, phenyl resorcinol, benzyl resorcinol, phenylethyl resorcinol, phenylpropyl resorcinol, p-chlorobenzyl resorcinol, 5-Chloro-2,4-Dihydroxydiphenyl Methane, 4′-Chloro-2,4-Dihydroxydiphenyl Methane, 5-Bromo-2,4-Dihydroxydiphenyl Methane, and/or 4″-Bromo-2,4-Dihydroxydiphenyl Methane.

Anilides or Bigunides: Triclocarban, carbanilide, salicylanilide, tribromos alan, tetrachlorosalicylanilide, fluorosalan, chlorhexidine gluconate, chlorhexidine hydrochloride, trichlorocarbanilide and mixtures thereof. Halogenated Salicylanilides such as 4′,5-dibromosalicylanilide 3,4′,5-trichlorosalcylanilide, 3,4′,5-tribromosalicylanilide, 2,3,3′,5-tetrachlorosalicylanilide, 3,3,3′,5-tetrachlorosalicylanilide, 3,5-dibromo-3′-trifluoromethyl salicylanilide, 5-n-octanoyl-3′-trifluoromethyl salicylanilide, 3,5-dibromo-4′-trifluoromethyl salicylanilide, 3,5-dibromo-3′-trifluoro methyl salicylanilide (Fluorophene). Halogenated Carbanilides such as 3,4,4′-trichlorocarbanilide, 3-trifluoromethyl-4,4′-dichlorocarbandide, and/or 3,3,4′-trichlorocarbanilide.

Bisphenolic Compounds: Bisphenol A, 2′-methylene his (4-chlorophenol), 2,2′-methylene his (3,4,6-trichlorophenol) (hexachlorophene), 2,2′-methylene his (4-chloro-6-bromophenol), bis-(2-hydroxy-3,5-dichlorophenyl) sulfide, and/or bis-(2-hydroxy-5-chlorobenzyl) sulfide.

Essential oil derived compounds: The desired antimicrobial agents for the present invention is isolated from various essential oils, for example, peppermint oil, spearmint oil, other mint oils, clove oil, wintergreen oil, anise oil, tea tree oil, lavender oil, pine oil, lemongrass oil, lemon oil, parsley oil, orange oil, clove oil, thyme oil, grapefruit oil, clove bud oil, aniseed oil, basil oil, black pepper oil, camphor oil, cananga oil, cardamom oil, cassia oil, cedarwood oil, cinnamon bark oil, cinnamon leaf oil, citrus oil, mint-type oils, citronella oil, eucalyptus oil, fennel oil, geranium oil, ginger oil, guaiacwood oil, juniper berry oil, lime oil distilled, litsea cubeba oil, patchouli oil, berry oil, pimento leaf oil, sandalwood oil, sage oil, sassafras oil, vetyver oil, bergamot oils, spice oils, origanum oil, pimento oil, buchu oil, caraway oil, carrot seed oil, copaiba oil, geranium oil, rosemary oil, targette oil, mace oil, nutmeg oil, cypress oil, cinnamon oil, coconut oil, fish oil, palm oil, mineral oil, apricot oil, cassia oil, castor oil, coriander oil, corn oil, cottonseed oil, peanut oil, soyabean oil, vegetable oil, pine seed oil, abyssinica oil, macadamia nut oil and/or limnanthes alba oil.

The preferred isolated constituents of essential oils or their semi-synthetic derivatives include, but are not limited to menthone, menthyl acetate, neomenthol, piperitone, pulegone, betacaryophyllene, betacaryophyllene-epoxide, alpha-pinene, beta-pinene, germacrene-D, 1,8-cineol, linalool, menthofurane, camphene, beta-hexenyl phenylacetate, d-limonene, 1-limonene, d1-limonene, alpha-citral, beta-citral (geranol), alpha-terpinene, gamma-terpinene, 2-dodecanal, 2-pentenal, cadiene, decylaldehyde, linalool, terpineol, linalyl esters, terpinyl acetate, decanal, C8 to C10-12 aldehydes, acids, amyl salicylate, cavacrol, dihydroeugenol, eugenol, hexyl eugenol, hexyl salicylate, isoeugenol, methyl eugenol, methyl isoeugenol, methyl salicylate, tert-butyl cresol, thymol, vanillin, cedrene, cineole, citral, citronellal, citronellol, cymene, paradihydrolinalool, dihydromyrcenol, farnesol, hexyl cinnamaldehyde, hydroxycitronallol, hydroxycitronellal, isocitral, linalool, longifolene, menthol, nerol, nerolidiol, phellendrene, terpinene, tetrahydromyrcenol, carvacrol, dihydroguaiaretic acid, nerolidole, gamma-decalactone and delta-decalactone, monocaprin, monolaurin, cinnamic acid, decanoic acid, 3-hydroxydecanoic acid, 9-decenoic acid, senecionic acid, nonanol, decanol, nonanal, decanal, amyl propionate, anethole, anisic aldehyde, cis-3-hexenol, damascone, ethyl acetoacetate, isoamyl acetate, L-menthol, methyl cinnamate, cyclamen aldehyde, diphenyl oxide, ethyl vanilin, eucalyptol, L-methyl acetate, longifolene, methyl cedryl ketone, methyl chavicol, methyl salicylate, musk ambrette, musk ketone, musk xylol, phenyl ethyl alcohol, vanilin, I-carvone, terpenes, alpha-citronellol, citronellyl acetate, citronellyl nitrile, p-cymene, dihydroanethole, dihydrocarveol, d-dihydrocarvone, dihydrolinalool, dihydromyrcene, dihydromyrcenol, dihydromyrcenyl acetate, dihydroterpineol, dimethyloctanal, dimethyloctanol, dimethyloctanyl acetate, estragole, ethyl-2 methylbutyrate, fenchol, geraniol, geranyl acetate, geranyl nitrile, hexenal, trans-2-hexenol, cis-3-hexenyl isovalerate, cis-3-hexanyl-2-methylbutyrate, hexyl isovalerate, hexyl-2-methylbutyrate, hydroxycitronellal, lonone, isobornyl methylether, linalool oxide, linalyl acetate, menthane hydroperoxide, I-methyl acetate, methyl hexyl ether, methyl-2-methylbutyrate, 2-methylbutyl isovalerate, myrcene, nerol, neryl acetate, 3-octyl acetate, phenyl-ethyl-2-methylbutyrate, cis-pinane, pinane hydroperoxide, pinanol, pine ester, α-pinene oxide, plinol, plinyl acetate, pseudo lonone, rhodinol, rhodinyl acetate, α-terpinene, γ-terpinene, terpinene-4-ol, terpinolene, terpinyl acetate, tetrahydrolinalool, tetrahydrolinalyl acetate, phellandrene, pinene, methylheptenone, safrol, eugenyl acetate, caryophyllene, borneol, bornyl esters, camphor, menthyl esters, safrole, acetaldehyde, chavicol, cinnamyl acetate, α-thujone, β-thujone, fenchone alone or in combination.

The blend of antimicrobial agents can be present in a wide range of concentrations depending on the type of blend of antimicrobial agents and the use of the composition. For cleaning or disinfectant concentrates, the blend of antimicrobial agent will typically be present in an amount by weight of about 1% to about 40%, more particularly from about 1.5% to about 20% and in accordance with certain embodiments from about 2% to about 10% of the concentrate. For use compositions, the blend of antimicrobial agent will typically be present in an amount by weight of about 1 ppm to about 10000 ppm, more particularly from about 2 ppm to about 5000 ppm and in accordance with certain embodiments from about 5 ppm to about 4000 ppm of the diluted cleaning and disinfectant composition.

A blend of antimicrobial agents is present in the composition as a microemulsion. The particle size of the blend of antimicrobial agents is in the range of from about 5 to 1000 nm, more particularly from about 5 to 500 nm, still more particularly from about 10 to 100 nm and in accordance with certain embodiments from about 10 to 30 nm. Particle size refers to average particle radius and can be determined using dynamic light scattering techniques and equipment known to those of skill in the art. Optical clarity can be measured using a turbidimeter or nephelometer. A reading of less than 200 nephelometric turbidity units (NTU), more particularly less than about 100 NTU at 25° C. typically indicates that the blend of antimicrobial agents of the present application is stable in the solution.

For particular compositions of the polymer-surfactant-complex and antimicrobial agent, the weight ratio of antimicrobial agents blend to surfactant-polymer complex may be about 1:80 to 5:0.5, preferably about 1:0.2 to 1:40.

The weight ratio of antimicrobial agent blend to surfactant suitably is about 1:40 to 2:1,more particularly about 1:10 to 5:1,preferably about 1:8 to 1:1 and in certain embodiments about 1:5 to 1:3.

The weight ratio of antimicrobial agent blend to polymer suitably may be about 1:10 to 5:0.5, more particularly about 1:0.2 to 1:2,preferably about 1:2 to 1:0.5.

For concentrates, the antimicrobial agent blend will typically be present in an amount by weight of about 1% to about 40%, more particularly from about 1.5% to about 30% and in accordance with certain embodiments from about 2% to about 20% of the concentrate. Moreover, in some cases, the concentrate can also function as a use composition.

The use levels of antimicrobial agents blend for the preparation of disinfectant or cleaning compositions may be about 0.01% wt to about 5.0% wt, more particularly 0.01% wt to about 1.0% wt.

The weight ratio of the surfactant to the polymer is typically about 20:1 to 1:20, preferably about 10:1 to 1:10 and more particularly about 5:1 to 1:5.

In an embodiment of the present application, a heat and cold stable antimicrobial disinfectant and/or cleaning concentrate composition is stable for at least six months at room temperature or stable for at least 3 freeze/thaw cycles wherein temperature cycled from 50° C. to −24° C. in every 24 hours or stable for at least 2 weeks at about 50° C.

According to one embodiment of the present application, the antimicrobial disinfectant and/or cleaning composition is capable of exhibiting antimicrobial activity by killing or inhibiting gram (−) bacteria, gram (+) bacteria and Methicillin-resistant staphylococcus aureus (MRSA) bacterial strains. The non-limiting gram (−) bacterial strains of the present application would include Escherichia coli, Salmonella species, Shigella species, Enterobacteriaceae species, Pseudomonas species, Moraxella species, Helicobacter species, Stenotrophomonas species, Bdellovibrio species, acetic acid bacteria, Legionella species, alpha-proteobacteria as Wolbachia, cyanobacteria, spirochaetes, green sulfur and/or green non-sulfur bacteria. The non-limiting gram (+) bacterial strains of the present application would include Staphylococcus species, Streptococcus species, Enterococcus species, Bacillus species, Corynebacterium species, Nocardia species, Clostridium species, Actinobacteria species, and Listeria species.

In accordance with particular embodiments of the present application, the compositions primarily comprise a water-soluble matrix composite made of polymer-surfactant complex, a blend of antimicrobial agents and suitable additives. The additives may be added to the desired composition to modify or provide certain properties to the end-use compositions. Examples of such additives that can be added include, but are not limited to flavors, colors, thickeners, pH adjusting agents including organic and inorganic salts, fragrances, fragrance solubilizers/enhancers, insect-repellants, opacifiers, skin conditioning agents, skin protectants, anti-caking agent, corrosion inhibitor, defoamer, bleaching agents, anti-spotting agents, anti-oxidants, optical brighteners, hydrotropes, light stabilizers, enzymes, sequestering/scale-inhibiting agents, ultraviolet light stabilizers, co-solvents, and/or humectants.

According to one embodiment of the present application it is desired to provide volatile organic compounds (VOC) free microemulsion based antimicrobial disinfectant or cleaning composition. The suitable VOC-free solvents for the present application are selected from the group consisting of but are not limited to glycols, polyglycols, ethers of glycol, esters of glycol, cyclic diols, non-cyclic diols, glycerols, ethers or esters of glycerol, mixture of glycerols and/or mixture of polyglycerols.

The preferred glycols are ethylene glycol, 1,2-propylene glycol, 1,3-propylene glycol, diethylene glycol, triethylene glycol, tetraethylene glycol, pentaethylene glycol, hexaethylene glycol, heptaethylene glycol, octaethylene glycol, nonaethylene glycol, decaethylene glycol, 3-methyl-1,5-pentanediol, 2,3-dimethyl-2,3-butanediol, 2,4-dimethyl-2-ethyl-hexane-1,3-diol, 2,2-dimethyl- 1,3-propanediol, 2-ethyl-2-butyl-1,3-propanediol, 2-ethyl-2-isobutyl-1,3-propanediol, 1,2-butanediol, 1,3-butanediol, 1,4-butanediol, 1,4-pentanediol, 1,5-pentanediol, 1,6-hexanediol, 2,2,4-tetra methyl-1,6-hexanediol, thiodiethanol, 1,2-cyclohexanedimethan-ol, 1,3-cyclohexanedimethanol, 1,4-cyclohexanedimethanol, 2,2,4-trimethyl-1,3-pentanediol, 2,2,4-tetramethyl-1,3-cyclobutanediol, p-xylenediol, hydroxypivalyl hydroxypivalate, 1,10-decanediol and/or hydrogenated bisphenol A. The appropriate polyols of the present invention would include, but are not limited to, trimethylolpropane (TMP), pentaerythritol (PE), trimethylolethane, erythritol, threitol, dipentaerythritol, sorbitol, glycerine, and the like. Several apt polypropylene glycols of the present invention would include that are sold by the Dow Chemical Company under the trade names PT250, PT700, PT3000, P425, P1000TB, P1200, P2000, P3000TB, and P4000. Glycerol for the present application is selected from group comprised of diglycerol, triglycerol, tetraglycerol, pentaglycerol, hexaglycerol, heptaglycerol, octaglycerol, oligomer, ethylene glycol diglycidyl ether, polyethylene glycol diglycidyl ether, glycerol polyglycidyl ether, diglycerol polyglycidyl ether, polyglycerol polyglycidyl ether, sorbitol polyglycidyl ether, pentaerythritol polyglycidyl ether, propylene glycol diglycidyl ether, and propylene glycol diglycidyl ether and a combination thereof. The “polyglycerol” (referred to hereinafter as PG) includes an oligomeric and/or polymeric chain composed of monomeric glycerol (i.e., HOCH₂CH(OH)CH₂OH) connected by ether linkages at their hydroxyl residue. The typical number of glycerol monomer units in a particular polyglycerol is characterized by a number. According to the present application, the isolated or purified polyglycerol polyol ingredients of the present application may contain, on average, from about 2 to about 20 monomer glycerol units. However, the polyglycerols suitable for use in the present invention would include PG2,PG3,PG4,PGS, PG6, PG7, PG8, PG9, PG10, PG11,PG12,PG13,PG14,PG15, PG16, PG17, PG18, PG19, PG20, and a combination thereof. The commercially available polyglycerol for the present application are Polyglycerol-(Solvay), Polyglycerol-4 (Solvay), Polyglycerol-5, Polyglycerol-6, and/or Polyglycerol-10.

In preparing VOC-free disinfectant/cleaning concentrate composition of the present application, it is preferred to add suitable thickening agents to provide a desirable consistency to the concentrate. Examples of useful thickening agents include carboxyvinyl polymers, carrageenan, hydroxyethyl cellulose, laponite and water soluble salts of cellulose ethers such as sodium carboxymethylcellulose and sodium carboxymethyl hydroxyethyl cellulose, copolymers of lactide and glycolide monomers, carbomers. Natural gums such as gum karaya, xanthan gum, gum arabic, and gum tragacanth can also be used. Colloidal magnesium aluminum silicate or finely divided silica can be used as part of the thickening agent to further improve texture. Some thickening agents, however, except polymeric polyether compounds, e.g., polyethylene or polypropylene oxide (M.W. 300 to 1,000, 000), capped with alkyl or acyl groups containing 1 to about 18 carbon atoms. Carbomers are commercially available from B.F. Goodrich as the Carbopol Series. Particularly preferred carbopols include Carbopol 934, 940, 941, 956, and mixtures thereof. Thickening agents are usually present in an amount from about 0.1% to about 25% by weight of the disinfectant/cleaning concentrate composition. However, the preferred amount of thickening agent for the present composition is the range of about 0.01-5.0% by weight, preferably about 0.05-2.0%.

Optionally, one or more coloring agents are employed to adjust the appearance of the disinfectant and/or cleaning concentrate compositions in order to enhance their appearance. Coloring agents are incorporated in the compositions in a required amount to provide desired appearance to concentrate compositions. Such a coloring agent/s may be added in a conventional technique according to the teachings of prior-art.

The coloring agents or colorants used in the present application include natural foods colors and dyes suitable for food, drug and cosmetic applications. These colorants are also known as F.D. & C. dyes and lakes and are preferably water-soluble in nature. Examples of representative colorants include, but are not limited to, disodium salt of 5,5-indigotindisulfonic acid (Blue No.2), 4-[4-(N-ethyl-p-sulfonium benzylamino) diphenylmethylene]-[1-(N-ethyl-N-p-sulfoniumbenzyl)delta-2,5-cyclohexadien eimine] (Green No.1), Yellow No. 10, Green No. 3 comprising a triphenylmethane dye, FD&C Blue # 1,FD&C Yellow #5, FD&C Yellow #10, FD&C Red #3,FD&C Red #40; caramel color or powder (#05439), chocolate shade (#05349), green lake blend (#09236), kowet titanium dioxide (#03970), yellow liquid color (#00403), and nitrites. A full recitation of all F.D. & C. and D. & C. dyes and their corresponding chemical structures may be found in the Kirk-Othmer Encyclopedia of Chemical Technology, Volume 5, pages 857-884,which text is accordingly incorporated herein by reference. These coloring agents may be incorporated in amount up to about 3%, more particularly up to about 2%, and in some cases less than about 1% by weight of the disinfectant and/or cleaning compositions.

The pH of the disinfectant or cleaning composition can be controlled within any desired range. For example, few antimicrobial agents and/or other ingredients are effective at acidic or lower pH, while other antimicrobial agents and/or other components are very effective at alkaline or higher pH. In order to attain the desired pH range various pH modifiers may be employed in the present disinfectant or cleaning composition. Some examples of basic pH modifiers that may be used in the present application include, but are not limited to, ammonia; mono-, di-, and tri-alkyl amines; mono-, di-, and tri-alkanolamines; alkali metal and alkaline earth metal hydroxides; alkali metal and alkaline earth metal silicates; and mixtures thereof. Specific examples of basic pH modifiers are ammonia; sodium, potassium, and lithium hydroxide; sodium, potassium, and lithium meta silicates; monoethanolamine; triethylamine; isopropanolamine; diethanolamine; and triethanolamine.

The suitable acidic pH modifying agents that can be employed in the present application include, but are not limited to, mineral acids, carboxylic acids and polymeric acids. Specific examples for mineral acids are hydrochloric acid, nitric acid, phosphoric acid, and sulfuric acid. Examples for appropriate carboxylic acids are citric acid, glycolic acid, lactic acid, maleic acid, malic acid, succinic acid, glutaric acid, benzoic acid, malonic acid, salicylic acid, gluconic acid, and mixtures thereof. Examples for suitable polymeric acids include straight-chain poly(acrylic) acid and its copolymers (e.g., maleic-acrylic, sulfonic-acrylic, and styrene-acrylic copolymers), cross-linked polyacrylic acids having a molecular weight of less than about 250,000, poly(methacrylic) acid, and naturally occurring polymeric acids such as carageenic acid, carboxymethyl cellulose, and alginic acid.

The desired pH range for the present disinfectant or cleaning composition is between about 3 to about 12, and in some embodiment, it is preferably between about 5 to about 10. The utility levels of the pH modifying agent may be present in an effective amount required to achieve the desired pH level. In a preferred embodiment, the pH modifier is present in the disinfectant or cleaning composition in an amount between about 0.001% to about 5% by weight of the composition, and in another embodiment between about 0.1% to about 2.5% by weight of the composition.

Optionally, a perfume or fragrance obtained from natural or synthetic source is employed for the present disinfectant or cleaning concentrate composition. The fragrance may be used along with a suitable solvent, diluents or carrier. Fragrances may be added in any conventionally known method, for example, admixing to a composition or blending with other ingredients used to form a composition, in amounts which are found to be useful to increase or impart the desired scent characteristics to the disinfectant or cleaning compositions.

Fragrances for the present application can be one or more selected from the following non-limiting group of compounds such as essential oils, absolutes, resinoids, resins, concretes, hydrocarbons, alcohols, aldehydes, ketones, ethers, acids, esters, acetals, ketals, nitriles, including saturated and unsaturated compounds and aliphatic, carbocyclic and heterocyclic compounds. Examples of such fragrances can be at least one selected from the group consisting of lavender, rose, jasmin, pine, woody, floral, fruity, lemon, lime, apple, peach, raspberry, strawberry, banana, plum, apricot, vanilla, pear, eucalyptus, tutti frutti, oriental, sweet, amber, paola, muguet, citronella, geraniol, geranyl acetate, linalol, linalyl acetate, tetrahydrolinalool, citronellol, citronellyl acetate, dihydromyrcenol, dihydromyrcenyl acetate, nopol acetate, 2-phenylethanol, 2-phenylethyl acetate, benzyl alcohol, benzyl acetate, benzyl salicylate, benzyl benzoate, styrallyl acetate, amyl salicylate, dimethylbenzylcarbinol, trichloromethylphenycarbinyl acetate, p-term-butylcyclohexyl acetate, isonomyl acetate, vetiveryl acetate, vetiverol, alpha-n-amylcinammic aldehyde, aphaohexylcinammic aldehyde, 2-methyl-3-(p-term-butyl phenyl)propanal, 2-methyl-3-(p-isopropylphenyl)propanal, 3-(p-tert.butylphenyl)propanal, tricyclodecenyl acetate, tricyclodecenyl propionate, 4-(4-hydroxy-4-methylpentyl)-3-cyclohexenecarbaldehyde, 4-(4-methyl-3-pentenyl)-3-cyclohexenecarbaldehyde, 4-acetoxy-3-pentyltetrahydropyran, methyl dihydroj asmonate, 2-n-heptylcyclopentanone, 3-methyl-2-pentylcyclopentanone, n-decanal, n-dodecanal, 9-decenol-1,phenoxyethyl isobutyrate, phenylacetaldehyde dimethyl acetal, phenylacetaldehyde diethyl acetal, geranonitrile, citronellonitrile, cedryl acetate, 3-isocamphylcyclohexanol, cedryl methyl ether, isolongifolanone, aubepine nitrile, aubepine, heliotropine, coumarin, eugenol, vanillin, diphenyl oxide, hydroxycitronellal, ionones, methyl ionones, isomethyl ionones, irones, cis-3-hexenol and esters thereof, indane musk fragrances, tetralin musk fragrances, isochroman musk fragrances, macrocyclic ketones, macrolactone musk fragrances, ethylene brassylate, aromatic nitromusk fragrances. The quantity of fragrance component present in the present concentrate composition is in the range of from about 1-40% by weight or volume, or any range or a specific value within that range, preferably in a quantity from about 5-20% by weight or volume, and more preferably in a quantity of from about 10-15% by weight or volume of the composition.

In a preferred embodiment of the invention, the sequestering or chelating agent is employed for the preparation of aqueous VOC free disinfectant or cleaning composition to aid in the solubility of components or to counteract the effect of hard water which may be used to prepare the concentrate or their diluted compositions for the customer's end-use. The suitable organic or inorganic sequestering or chelating is selected from the group comprising polyols, gluconates, sorbitals, mannitols, carbonates, hydroxamates, catechols, α-amino carboxylates, alkanolamines, metal-ion sequestrants, hydroxy-carboxylic acids, aminocarboxylic acids, amino polycarboxylic acids, polyamines, polyphosphates, phosphonic acids, crown ethers, amino acids, polycarboxylic acids, cyclodextrin, phosphonates, polyacrylates or polymeric polycarboxylates, condensed phosphates. Sequestering or chelating agents of the present composition include, but are not limited to, acetic acid, adenine, adipic acid, ADP, alanine, alanine, albumin, arginine, ascorbic acid, asparagine, aspartic acid, ATP, benzoic acid, n-butyric acid, casein, citraconic acid, citric acid, cysteine, dehydracetic acid, desferri-ferrichrysin, desferri-ferrichrome, desferri-ferrioxamin E, 3,4-dihydroxybenzoic acid, diethylenetriaminepentaacetic acid (DTPA), hydroxylpropylenediaminetetraacetic acid (DPTA), dimethylglyoxime, dimethylpurpurogallin, EDTA, formic acid, fumaric acid, globulin, gluconic acid and its alkali metal salts, glutamic acid, glutaric acid, glycine, glycolic acid, glycylglycine, glycylsarcosine, guanosine, histamine, salicylic, pimalic and sulfamic acid, salicylic, glutaric, malonic acid, 1,10-phenanthroline, 2-pyridylacetic acid, 5-formylfuran sulfonic acid, N-tris(hydroxymethyl)methyl-2-aminoethanesulfonic acid, itaconic acid, chelidonic acid, 3-methyl-1,2-cyclopentanedione, glycolamide, histidine, 3-hydroxyflavone, inosine, iron-free ferrichrome, isovaleric acid, itaconic acid, kojic acid, lactic acid, leucine, lysine, maleic acid, malic acid, methionine, methylsalicylate, nitrilotriacetic acid (NTA), ornithine, orthophosphate, oxalic acid, oxystearin, phenylalanine, phosphoric acid, phytate, pimelic acid, pivalic acid, polyphosphate, proline, propionic acid, purine, pyrophosphate, pyruvic acid, riboflavin, salicylaldehyde, salicyclic acid, sarcosine, serine, sorbitol, succinic acid, tartaric acid, tetrametaphosphate, thiosulfate, threonine, trimetaphosphate, triphosphate, tryptophan, uridine diphosphate, uridine triphosphate, n-valeric acid, valine, xanthosine, triethylenetetraaminehexaacetic acid, N, N′-bis(o-hydroxybenzyl) ethylenediamine-N, N′ diacteic acid, ethylenebis-N, N′-(2-o-hydroxyphenyl)glycine, acetohydroxamic acid, desferroxamine-B, disulfocatechol, dimethyl-2,3-dihydroxybenzamide, mesitylene catecholamide (MECAM), 1,8-dihydroxynaphthalene-3,6-sulfonic acid, and 2,3-dihydroxynaphthalene-6-sulfonic acid, siderophores molecules, N,N-dicarboxymethyl-2-aminopentanedioic-acid, diethylenetriaminepentaacetic-acid, ethylene-diaminetetraacetates, nitriloacetates or N-(2-hydroxyethyl)nitrilodiacetates), 2,2-dichloropropionic acid, 2,2-dibromobutyric acid, trifluoroacetic acid, tribromoacetic acid, trichloroacetic acid, 2,3-dibromopropionic acid, 2,2-dichlorovaleric acid, 3-nitropropionic acid, triiodoacetic acid, 3(2,2,2-trichloroethoxy)propionic acid, 4-nitro-2-chlorobutyric acid, 2-bromo-2-nitropropionic acid, 2-nitroacetic acid, 2,4-dihydroxyphenyl acetic acid, 2,4-dichlorophenyl acetic acid, 3(2′, 4′-dibromophenoxy)propionic acid, 3(3′,5′-dinitrophenoxy) propionic acid, 3-phenyl-2,3-dibromopropionic acid, 3,5-dinitros alicylic acid, 3(3′-bromo-4′-nitrophenyl)propionic acid, 3(3′, 4′-dihydroxyphenyl) propionic acid alone or in combination. Further information on sequestering and chelating agents is disclosed in T. E. Furia, CRC Handbook of Food Additives, 2^{nd} Edition, pp. 271-294 (1972), and M. S. Peterson and A. M. Johnson (Eds.), Encyclopedia of Food Science, pp. 694-699 (1978) incorporated herein by reference in their entirety.

An optional embodiment of the present application is to further improve the cleaning composition by adding minor quantity of preservatives to the compositions. Such preservatives are selected from the group consisting of, but are not limited to Triazoles: Azaconazole, bromuconazole, cyproconazole, dichlobutrazol, diniconazole, hexconazole, metconazole, penconazole, propiconazole, tebuconazole, amitrole, azocyclotin, epoxyconazole, bitertanol, difenoconazole, fenbuconazole, fenchlorazole, fenethanil, fluquinconazole, flusilazole, flutriafol, imibenconazole, isozofos, myclobutanil, paclobutrazol, (+)-cis-1-(4-chlorophenyl)-2-(1H-1,2,4-triazol-1-yl)-cycloheptanol, tetraconazole, triadimefon, triadimenol, triapenthenol, triflumizole, triticonazole, uniconazole and their metal salts and acid adducts; Imidazoles: Imazalil, pefurazoate, prochloraz, triflumizole, hiazolecarboxanilides, 2′, 6′-dibromo-2-methyl-4-trifluoromethoxy-4′-trifluoromethyl-1,3-thiazole-5-carboxanilide and their metal salts and acid adducts. Succinate dehydrogenase inhibitors: Fenfuram, furcarbanil, cyclafluramid, furmecyclox, seedvax, metsulfovax, pyrocarbolid, oxycarboxin, Shirlan, mebenil (mepronil), benodanil, flutolanil (Moncut); Naphthalene derivatives: Terbinafine, naftifine, butenafine; 10, 10′ oxybisphenoxarsine; Benzimidazoles: carbendazim, benomyl, furathiocarb, fuberidazole, thiophonatmethyl, thiabendazole or salts thereof; Morpholine derivatives: tridemorph, fenpropimorph, falimorph, dimethomorph, dodemorph; aldimorph, fenpropidin and their salts with arylsulphonic acids, such as p-toluenesulphonic acid and p-dodecylphenyl-sulphonic acid; Dithiocarbamates: cufraneb, ferbam, mancopper, mancozeb, maneb, metam, metiram, thiram zeneb, ziram; Benzothiazoles: 2-mercaptobenzothiazole; Benzamides: 2,6-dichloro-N-(4-trifluoromethylbenzyl)-benzamide; Boron compounds: boric acid, boric esters, borax; Formaldehyde donors: benzyl alcohol mono-(poly)-hemiformal, oxazolidines, hexa-hydro-5-triazines, N-methylolchloracetamide, paraformadehyde, nitropyrine, oxolic acid, tecloftalam; Tris-N-(cyclohexyldiazeniumdioxy)-aluminium, N-(cyclo-hexyldiazeniumdioxy)-tributyl, K salts; Isothiazolones: N-Methylisothiazolin-3-one (MIT), 5-Chloro-2-methyl-4-isothiazolin-3-one (CMIT), 4,5-dichloro-N-oc tylisothiazolin-3-one (DC OIT), 2-Octyl-4-isothiazolin-3-one (OIT), 4,5-trimethylene-isothiazolinone, 1,2-Benzisothiazolin-3-one (BIT), N-butyl-1,2-benzisothiazolin-3-one (BBIT); Aldehydes, such as cinnamaldehyde, formaldehyde, glutardialdehyde, β-Br-cinnamaldehyde; Thiocyanates: thiocyanatomethylthiobenzothiazole, methylenebisthiocyanate, and the like; Quaternary ammonium compounds: benzyldimethyltetradecylammonium chloride, benzyldimethyldodecylammonium chloride, didecyldimethylammonium chloride; Iodine derivatives: diiodomethyl p-tolyl sulphone, 3-iodo-2-propinyl alcohol, 4-chlorophenyl-3-iodopropargyl formal, 3-bromo-2 3-diiodo-2-propenyl ethylcarbamate, 2,3,3-triiodoallyl alcohol, 3-bromo-2,3-diiodo-2-propenyl alcohol, 3-iodo-2-propynyl-n-butylcarbamate (IPBC), 3-iodo-2-propinyl-n-butylurea, 3-iodo-2-propinyl-n-hexylcarbamate, 3-iodo-2-propinyl-cyclohexylcarbamate, 3-iodo-2-propinyl-N-phenylcarbamate (IPPC); Phenol derivatives: tribromophenol, tetrachlorophenol, 3-methyl-4-chlorophenol, 3,5-dimethyl-4-chlorophenol, phenoxyethanol, dichlorophen, o-phenylphenol, m-phenylphenol, p-phenylphenol, 2-benzyl-4-chlorophenol and their alkali metal salts and alkaline earth metal salts; Microbicides: chloroacetamide, N-methylolchloroacetamide, bronopol, bronidox, tectamer including 2-bromo-2-nitro-1,3-propanediol, 2-bromo-4′-hydroxy-acetophenone, 2,2-dibromo-3-nitrilo-propionamide, 1,2-dibromo-2,4-dicyanobutane, β-β-β-nitrostyrene; Pyridines: 1-hydroxy-2-pyridinethione and/or their Na, Fe, Cu, Mn, Zn salts thereof, Zinc pyrithione (ZnPy) tetrachloro-4-methylsulphonylpyridine, pyrimethanol, mepanipyrim, dipyrithione; Dialkyldithiocarbamates: sodium salts of dialkyldithiocarbamates, tetramethylthiuram disulphide, potassium N-methyl-dithiocarbamate; Nitriles: 2,4,5, 6-tetrachloroisophthalonitrile, dis odium cyano-dithioimidocarbamate; Quinolines: 8-hydroxyquinoline and their inorganic salts thereof, particularly, Cu salt; Other Biocides: Mucochloric acid, 5-hydroxy-2(5H)-furanone, 4,5-Dichlorodithiazolinone, 4,5-benzodithiazolinone, 4,5-trimethylenedithiazolinone, 4,5-dichloro-(3H)-1,2-dithio1-3-one, 3,5-dimethyl-tetrahydro-1,3,5-thiadiazine-2-thione, N-(2-p-Chlorobenzoylethyl)-hexaminium chloride, potassium N-hydroxymethyl-N′-methyl-dithiocarbamate, 2-Oxo-2-(4-hydroxy-phenyl) acethydroximic acid chloride, Phenyl 2-chloro-cyano-vinyl sulphone, Phenyl 1,2-dichloro-2-cyano-vinyl sulphone, triclosan, dehydroacetic acid (DHA).

The disinfectant and/or cleaning composition optionally can be provided with optical brighteners to keep the appearance of the composition agreeable. Such optical brighteners would include, but are not limited to, benzotriazole derivative and/or a stilbene disulfonic acid derivative. Particularly preferred optical brighteners are 2-(2H-benzotriazole-2-yl)-4-methyl-6-dodecyl-phenol, a reaction product of 3-(3-(2H-benzotriazole-2-yl)-5-tert-butyl4-hydroxyphenyl)-propionic acid methyl ester and polyethylene glycol 300 and/or a bis(4,4′-triazinylamino)-stilbene-2,2′-disulfonic acid derivative (Uvitex BAM of the firm of Ciba-Geigy AG). The preferred concentration of optical brighteners is in the range of about 0.001 to 3% by weight, and more preferably, in a concentration of 0.01 to 0.5% by weight.

A hydrotrope compound may be used to enhance the water solubility of compounds or helps in stabilizing the surfactant of concentrate composition. It should be noted that hydrotrope compound is optional and can be avoided if it is not needed. Mostly, the hydrotrope compound is employed to stabilize surfactant. Additionally, the hydrotropes are useful in maintaining the organic materials including the surfactant readily dispersed in the aqueous disinfectant or cleaning solution.

Examples of the hydrotropes include the sodium, potassium, ammonium and alkanol ammonium salts of cumene, xylene, toluene, ethylbenzoate, isopropylbenzene, C₁-C₈ alkyl, naphthalene, alkyl benzene/alkyl naphthalene sulfonates, phosphate esters of alkoxylated alkyl phenols, phosphate esters of alkoxylated alcohols, C₁ to C₈ alkyl polyglycosides, sodium, potassium and ammonium salts of the alkyl sarcosinates, salts of cumene sulfonates, amino propionates, diphenyl oxides, disulfonates, alkyl dimethyl amine oxides, and alkyl diphenyloxide disulfonates. Other useful hydrotropes include sodium polynaphthalene sulfonate, sodium polystyrene sulfonate, sodium methyl naphthalene sulfonate, and disodium succinate.

The hydrotrope compound can be provided in the concentrate in an amount sufficient to stabilize the surfactant. When the hydrotrope component is used, it can be provided in an amount of between about 0.001 wt. % and about 25.0 wt. % based on the weight of the concentrate, and in some embodiments, it can be provided in an amount of between about 0.01 wt. % and about 15 wt. % of the concentrate.

Optionally, the sufficient amount of corrosion inhibitor compound may be provided in the present disinfectant or cleaning composition to provide desired level of corrosion inhibition. The corrosion inhibitor compound can be provided in an amount at least about 0.001 wt. %. Examples of particular corrosion inhibitors include maleic anhydride, phthalic anhydride, benzotriazole (BZT), resorcinol, carboxybenzotriazole, diethyl hydroxylamine, lactic acid, citric acid or salts thereof, catechol, pyrogallol, gallic acid or esters thereof, salicyl alcohol, salicyl aldoxime, alizarin, fructose, ammonium thiosulfate, tetramethylguanidine, 2-mercapto-5-methylbenzimidazole, 2-mercaptothiazoline, 3-mercapto-1,2-propanediol, 3-(2-aminophenylthio)-2-hydroxymercaptan, 3-(2-hydroxyethylthio)-2-hydroxypropyl-mercaptan, and mixtures thereof.

The present antimicrobial disinfectant and/or cleaning concentrate composition also can contain optional skin conditioners and/or protectants. Examples of skin conditioners include emollients, humectants, occlusive skin conditioners and the like. Suitable skin conditioners for the present application is selected from the group including but not limited to cetyl myristate, glyceryl dioleate, isopropyl myristate, lanolin, methyl laurate, PPG-9 laurate, soy stearyl, octyl palmitate, PPG-5 lanoate, glucamine, pyridoxine glycol, aluminum lanolate, corn oil, methicone, coconut oil, stearyl stearate, phenyl trimethicone, trimyristin, olive oil, synthetic wax, aloe, cholesterol, cystine, keratin, lecithin, egg yolk, glycine, PPG-12,retinol, salicylic acid, orotic acid, vegetable oil, soluble animal collagen. The skin conditioners can be used alone, or in combination with a skin protectant, like petroleum, cocoa butter, calamine, and/or kaolin. Additional examples of skin conditioners and protectants can be found in “CTFA Cosmetic Ingredient Handbook, ” J. M. Nikitakis, ed., The Cosmetic, Toiletry and Fragrance Association, Inc., Washington, D.C. (1988) incorporated herein by reference in its entirety.

The disinfecting and/or cleaning composition may include antioxidants to facilitate the enhanced shelf-life of the composition. Exemplary antioxidants that can be used include vitamins such as vitamin E, vitamin E acetate, vitamin C, vitamin A, and vitamin D, and derivatives thereof. Additional exemplary antioxidants include but are not limited to propyl, octyl and dodecyl esters of gallic acid, butylated hydroxyanisole (BHA), butylated hydroxytoluene (BHT), and nordihydroguaiaretic acid, and alkylated parabens. Another type of antioxidant includes a reducing component such as a reducing sugar to stabilize the disinfectant active component, for example, glucose. In general, the required amount of antioxidant for the present composition is in the range of about 0.2 wt. % to about 2 wt. %, and can be provided in an amount of about 0.5 wt. % to about 1.5 wt. %, based on the total weight of the disinfecting and/or cleaning composition. It should be appreciated that the disinfecting and/or cleaning composition can be provided without an antioxidant.

In another embodiment of the present application, the antimicrobial compositions disclosed herein optionally comprise an anti-foam or suds suppression agent. Anti-foam agent can be present from about 0.0001% to about 10%, preferably from about 0.001% to about 8%, most preferably from about 0.005% to about 5% by weight of the antimicrobial composition. The anti-foam agent employed to stop any unwanted foam generated while manufacturing highly concentrated aqueous composition of the present application. The preferred antifoaming agent is selected from a group consisting of silicone based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination. Silicone based anti-foam techniques and other anti-foam agents useful herein are extensively illustrated in “Defoaming, Theory and Industrial Applications”, Ed., P. R. Garrett, Marcel Dekker, N.Y., 1973, ISBN 0-8247-8770-6, incorporated herein by reference.

As used herein, the term “concentrate” in this application and claims is the pre-consumer dilution and composition of the disinfectant and/or cleaning composition which is essentially the form of the product prepared for sale to the consumer with necessary product shelf-life. Such a consumer is expected to dilute the concentrate with water to form a disinfectant and/or cleaning composition. In the same way, what is to be understood by the term “disinfectant cleaning compositions” are the water diluted compositions which are expected to be prepared by the consumer or other end-user by mixing a precise amount of the “concentrate” with water in order to form an appropriately diluted disinfectant and/or cleaning composition which is suitable for use in disinfectant and/or cleaning applications.

The compositions according to the application include both disinfectant and/or cleaning compositions and concentrates. The concentrate and end-use compositions differ only in the relative proportion of water to that of the other ingredients forming such compositions. The concentrated form of compositions more frequently used in the formation of a disinfectant and/or cleaning composition therefrom for consumer's use. Such may be easily prepared by diluting measured amounts of the concentrate compositions in water by the consumer or other end user in certain weight ratios of concentrate:water, and optionally, agitating the same to ensure even distribution of the concentrate in the water. The concentrate may be used without dilution i.e., in concentrate:water concentrations of 1:0, to extremely dilute dilutions such as 1:10000. Preferably, the concentrate is diluted in the range of 1:0.1 to 1:1000, preferably in the range of 1:10 to 1:500 but most preferably in the range of 1:50-1:200. The suitable dilution factor is determinable depending upon disinfectant and/or cleaning which is to be imparted to the subject.

As the disinfectant and/or cleaning concentrate compositions are aqueous, water forms a major part. Water is added in order to provide 100 wt % of the concentrate composition. The water may be tap water, but is preferably distilled, demineralized and/or de-ionized water. If the water is tap water, it should be appropriately filtered in order to remove any unwanted impurities such as organics or inorganics, especially mineral salts which may be present in hard-water which may thus interfere with the operation of the other ingredients of the composition. Water is added in required amount which is sufficient to form the concentrated compositions. The amount of water should be sufficient to ensure the retention of a substantially transparent characteristic when produced as a concentrate, but at the same time ensuring good blooming upon the addition of the concentrated composition to a further amount of water, or upon the addition of further water to the concentrate. Normally, water is present in the concentrate compositions in amounts in excess of about 50 wt %, preferably in amounts of in excess of about 70 wt %, but most preferably in amount of between 70-80 wt. % based on the total weight of the concentrate compositions according to the invention.

According to one embodiment of the application, there is provided a process for preparing a aqueous, stable, volatile organic compound (VOC)-free microemulsion based antimicrobial disinfectant and/or cleaning concentrate composition comprising the steps of (i) preparing a mixture of (a) water-soluble matrix composite and (b) a blend of antimicrobial agents; (ii) dissolving the mixture of step (i) in an suitable aqueous medium; and (iii) incorporating additives if any to the step (ii) and vigorously mixing the composition to result in stable, aqueous, homogenous, optically clear disinfectant concentrate composition.

Another embodiment of the present application discloses an aqueous, stable, volatile organic compound (VOC)-free microemulsion based antimicrobial disinfectant and cleaning concentrate composition effective against gram(+), gram(−) and Methicillin-resistant Staphylococcus aureus (MRSA) comprising (i) a water-soluble matrix composite made from (a) about 0.10% wt of polyvinyl pyrrolidone (PVP); and (b) about 0.5% wt of sodium lauryl sulfate (SLS); (ii) a blend of (a) about 4.0% wt of triclosan; and (b) about 8.0% wt of thymol; and (iii) optionally, one or more additives.

Yet another embodiment of the present application discloses a method for disinfecting and/or cleaning of hard surfaces where the presence of gram (+), gram (−) and/or Methicillin-resistant Staphylococcus aureus (MRSA) is suspected which comprises the steps of (i) diluting the concentrate composition of the present application in water in a weight ratio of concentrate : water of from 1:10 to 1:1000; and (ii) contacting the hard surface with a disinfecting and/or cleaning effective amount of the concentrate composition.

Still another embodiment of the present application discloses a method for disinfecting or cleaning of hard surfaces where the presence of gram (+), gram (−) and/or Methicillin-resistant Staphylococcus aureus (MRSA) is suspected which comprises the step of (i) diluting the concentrate composition of the present application in water in a weight ratio of concentrate : water of from 1:10 to 1:1000; (ii) contacting the hard surface with a disinfecting and/or cleaning effective amount of the concentrate composition; and (iii) applying steam of water vapor to enhance the penetration of disinfectant and/or cleaning components to result in enhanced antimicrobial efficacy.

The aqueous volatile organic compounds free antimicrobial disinfectant and/ or cleaning compositions of the present application can be normally utilized in any number of applications where disinfection is desired. The compositions of the present application can be used to treat variety of surfaces, particularly to a hard surface. Examples of hard surfaces to which the present composition can be applied include surfaces composed of refractory materials such as glazed and unglazed tile, porcelain, ceramics as well as stone including marble, granite, other stones surfaces, glass, metals, plastics, vinyl, laminated wood, and the like. The typical hard surfaces wherein the present composition can be employed by the consumers or end-users would include but are not limited to kitchens, bathrooms, furniture, automobile interiors, textiles, fabrics, carpeting, tiles, walls, floors, chrome, glass, vinyl, plastic, laminated woods, sinks, dishes, sanitary fittings, showers, shower curtains, wash basins, refrigerators, freezers, washing machines, automatic dryers, ovens, microwave ovens, cook-tops, countertops, cabinets, dishwashers. Moreover, the composition can also be employed in hard surfaces found in public places such as hospitals, hospital beds, clinics, medical centers, pharmaceutical facilities, clean rooms, central service areas, restaurants, hotels, public transport vehicles, public pools, showers, and/or laundries. The application of aqueous volatile organic compounds free antimicrobial disinfectant and/ or cleaning compositions of the present application can be in any conventional method such as spraying, brushing, applying through sponge or cloth, flooding and mopping. The compositions can be supplied in any type container such as bottles, spray bottles, aerosols, cans, plastic packages, bulk storage containers, totes, and the like.

Further, certain aspects of the present invention are illustrated in detail by way of the following examples. The examples are given herein for illustration of the invention and are not intended to be limiting thereof.

Disinfectant and Cleaning Compositions Made from LP Matrix Composite:

### Example 1

Disinfectant and cleaning composition comprising Triclosan (4 gm): In a 100 ML stoppered glass bottle, following ingredients were weighed in: 55.2 g of commercially available aqueous 29% sodium lauryl sulfate and 10.3 g 33% aqueous polyvinyl pyrrolidone polymer and 4 g Triclosan. The sample was stirred using a magnetic stirrer for a period of 2 hours. The total weight was adjusted to 100 g by addition of water and stiffing was continued until a homogeneous solution was produced. A homogeneous optically clear composition was produced, remained stable after storage for 6 months at ambient conditions. This composition was used as a bench mark for dilution at different levels of active ingredient, Triclosan for biological screening.

### Example 2

Disinfectant and cleaning composition comprising Thymol (8 gm): In a 100 ML stoppered glass bottle, following ingredients were weighed in: 55.2 g of commercially available aqueous 29% sodium lauryl sulfate and 10.3 g 33% aqueous polyvinyl pyrrolidone polymer and 8 g Thymol. The sample was stirred using a magnetic stirrer for a period of 2 hours. The total weight was adjusted to 100 g by addition of water and stiffing was continued until a homogeneous solution was produced. A homogeneous optically clear composition was produced, remained stable after storage for 6 months at ambient conditions.

### Example 3

Disinfectant and cleaning composition comprising Thymol (4 gm): In a 100 ML stoppered glass bottle, following ingredients were weighed in: 55.2 g of commercially available aqueous 29% sodium lauryl sulfate and 10.3 g 33% aqueous polyvinyl pyrrolidone polymer and 4 g Thymol. The sample was stirred using a magnetic stirrer for a period of 2 hours. The total weight was adjusted to 100 g by addition of water and stiffing was continued until a homogeneous solution was produced. A homogeneous optically clear composition was produced, remained stable after storage for 6 months at ambient conditions.

### Example 4

Disinfectant and cleaning composition comprising Triclosan (1.2g) and Thymol (2g): In a 100 ML stoppered glass bottle, following ingredients were weighed in: 55.2 g of commercially available aqueous 29% sodium lauryl sulfate and 10.3 g 33% aqueous polyvinyl pyrrolidone polymer and 1.2 g Triclosan and 2 g Thymol. The sample was stirred using a magnetic stirrer for a period of 2 hours. The total weight was adjusted to 100 g by addition of water and stiffing was continued until a homogeneous solution was produced. A homogeneous optically clear composition was produced, remained stable after storage for 6 months at ambient conditions.

### Example 5

Disinfectant and cleaning composition comprising Triclosan (2.2 g) and Thymol (3.6 g): In a 100 ML stoppered glass bottle, following ingredients were weighed in: 55.2 g of commercially available aqueous 29% sodium lauryl sulfate and 10.3 g 33% aqueous polyvinyl pyrrolidone polymer and 2.2 g Triclosan and 3.6 g Thymol. The sample was stiffed using a magnetic stirrer for a period of 2 hours. The total weight was adjusted to 100 g by addition of water and stirring was continued until a homogeneous solution was produced. A homogeneous optically clear composition was produced, remained stable after storage for 6 months at ambient conditions.

### Example 6

Disinfectant and cleaning composition comprising Triclosan (2.2 g) and Parachlorometaxylenol (PCMX, 3.6 g): In a 100 ML stoppered glass bottle, following ingredients were weighed in: 55.2 g of commercially available aqueous 29% sodium lauryl sulfate and 10.3 g 33% aqueous polyvinyl pyrrolidone polymer and 2.2 g Triclosan and 3.6 g PCMX. The sample was stirred using a magnetic stirrer for a period of 2 hours. The total weight was adjusted to 100 g by addition of water and stirring was continued until a homogeneous solution was produced. A homogeneous optically clear composition was produced, remained stable after storage for 6 months at ambient conditions.

### Example 7

Disinfectant and cleaning composition comprising Triclosan (2.2 g) and Orthophenyl phenol(OPP, 3.6 g): In a 100 ML stoppered glass bottle, following ingredients were weighed in: 55.2 g of commercially available aqueous 29% sodium lauryl sulfate and 10.3 g 33% aqueous polyvinyl pyrrolidone polymer and 2.2 g Triclosan and 3.6 g OPP. The sample was stirred using a magnetic stirrer for a period of 2 hours. The total weight was adjusted to 100 g by addition of water and stiffing was continued until a homogeneous solution was produced. A homogeneous optically clear composition was produced, remained stable after storage for 6 months at ambient conditions.

### Example 8

Disinfectant and cleaning composition comprising Thymol (2 gm), Triclosan (1.2 g) and Orthophenyl phenol (OPP, 2 g): In a 100ML stoppered glass bottle, following ingredients were weighed in: 55.2 g of commercially available aqueous 29% sodium lauryl sulfate and 10.3 g 33% aqueous polyvinyl pyrrolidone polymer and Thymol (2 gm), Triclosan (1.2 g) and OPP (2 g). The sample was stirred using a magnetic stirrer for a period of 2 hours. The total weight was adjusted to 100 g by addition of water and stirring was continued until a homogeneous solution was produced. A homogeneous optically clear composition was produced, remained stable after storage for 6 months at ambient conditions. There is no separation up on storage, and this composition can be used as a resource after dilution to produce disinfecting and/or cleaning wipes.

### Example 9

Disinfectant and cleaning composition comprising Triclosan (1.2 g) and Menthol (2 g): In a 100ML stoppered glass bottle, following ingredients were weighed in: 55.2 g of commercially available aqueous 29% sodium lauryl sulfate and 10.3 g 33% aqueous polyvinyl pyrrolidone polymer and 1.2 g Triclosan and 2 g Menthol. The sample was stirred using a magnetic stirrer for a period of 2 hours. The total weight was adjusted to 100 g by addition of water and stirring was continued until a homogeneous solution was produced. A homogeneous optically clear composition was produced, remained stable after storage for 6 months at ambient conditions.

### Example 10

Disinfectant and cleaning composition comprising Menthol (2 gm), Triclosan (1.2 g) and Orthophenyl phenol (OPP, 2 g): In a 100 ML stoppered glass bottle, following ingredients were weighed in: 55.2 g of commercially available aqueous 29% sodium lauryl sulfate and 10.3 g 33% aqueous polyvinyl pyrrolidone polymer and Menthol (2 gm), Triclosan (1.2 g) and OPP (2 g). The sample was stirred using a magnetic stirrer for a period of 2 hours. The total weight was adjusted to 100 g by addition of water and stirring was continued until a homogeneous solution was produced. A homogeneous optically clear composition was produced, remained stable after storage for 6 months at ambient conditions. There is no separation up on storage, and this composition can be used as a resource after appropriate dilution to produce disinfecting and/or cleaning wipes.

Disinfectant and Cleaning Compositions Made from HP Matrix Composite:

### Example 11

Disinfectant and cleaning composition comprising Triclosan (4 gm): In a 100 ML stoppered glass bottle following ingredients were weighed in: 34.5 g of commercially available aqueous 29% sodium lauryl sulfate and 30.3 g, 33% aqueous polyvinyl pyrrolidone polymer and 4 g Triclosan. The sample was stirred using a magnetic stirrer for a period of 2 hours. The total weight was adjusted to 100 g by addition of water and stiffing was continued until a homogeneous solution was produced. A homogeneous optically clear composition was produced, remained stable after storage for 6 months at ambient conditions.

### Example 12

Disinfectant and cleaning composition comprising Triclosan (1.2 gm): In a 100ML stoppered glass bottle following ingredients were weighed in: 34.5 g of commercially available aqueous 29% sodium lauryl sulfate and 30.3 g, 33% aqueous polyvinyl pyrrolidone polymer and 1.2 g Triclosan. The sample was stirred using a magnetic stirrer for a period of 2 hours. The total weight was adjusted to 100 g by addition of water and stiffing was continued until a homogeneous solution was produced. A homogeneous optically clear composition was produced, remained stable after storage for 6 months at ambient conditions.

### Example 13

Disinfectant and cleaning composition comprising Thymol (4gm): In a 100 ML stoppered glass bottle following ingredients were weighed in: 34.5g of commercially available aqueous 29% sodium lauryl sulfate and 30.3 g, 33% aqueous polyvinyl pyrrolidone polymer and 4g Thymol. The sample was stirred using a magnetic stirrer for a period of 2 hours. The total weight was adjusted to 100g by addition of water and stiffing was continued until a homogeneous solution was produced. A homogeneous optically clear composition was produced, remained stable after storage for 6 months at ambient conditions.

### Example 14

Disinfectant and cleaning composition comprising Triclosan (1.2 g) and Thymol (2 gm): In a 100 ML stoppered glass bottle following ingredients were weighed in: 34.5 g of commercially available aqueous 29% sodium lauryl sulfate and 30.3 g, 33% aqueous polyvinyl pyrrolidone polymer, Triclosan (1.2 g) and Thymol (2 g). The sample was stiffed using a magnetic stirrer for a period of 2 hours. The total weight was adjusted to 100 g by addition of water and stirring was continued until a homogeneous solution was produced. A homogeneous optically clear composition was produced, remained stable after storage for 6 months at ambient conditions.

### Example 15

Disinfectant and cleaning composition comprising Triclosan (2.2 g) and Thymol (3.6 gm): In a 100 ML stoppered glass bottle following ingredients were weighed in: 34.5 g of commercially available aqueous 29% sodium lauryl sulfate and 30.3 g, 33% aqueous polyvinyl pyrrolidone polymer, Triclosan (2.2 g) and Thymol (3.6 g). The sample was stirred using a magnetic stirrer for a period of 2 hours. The total weight was adjusted to 100 g by addition of water and stirring was continued until a homogeneous solution was produced. A homogeneous optically clear composition was produced, remained stable after storage for 6 months at ambient conditions.

### Example 16

Disinfectant and cleaning composition comprising Parachlorometaxylenol PCMX (2.2 g) and Thymol (3.6 gm): In a 100 ML stoppered glass bottle following ingredients were weighed in: 34.5g of commercially available aqueous 29% sodium lauryl sulfate and 30.3 g, 33% aqueous polyvinyl pyrrolidone polymer, PCMX (2.2 g) and Thymol (3.6 g). The sample was stirred using a magnetic stirrer for a period of 2 hours. The total weight was adjusted to 100 g by addition of water and stirring was continued until a homogeneous solution was produced. A homogeneous optically clear composition was produced, remained stable after storage for 6 months at ambient conditions.

### Example 17

Disinfectant and cleaning composition comprising Octanoic acid: In a 100 ML stoppered glass bottle following ingredients were weighed in: 1 g Octanoic acid, followed by 1 g solid polyvinyl pyrrolidone and 1 g Sodium lauryl sulfate and 5 g Tween 20 (food grade) followed by water to 90 g. The sample was stirred using a magnetic stirrer for a period of 2 hours. The total weight was adjusted to 100 g by addition of water and stirring was continued until a homogeneous solution was produced. A homogeneous optically clear composition was produced, at pH 4.6, remained stable after storage for 6 months at ambient conditions.

### Example 18

Disinfectant and cleaning composition comprising Octanoic acid: In a 100 ML stoppered glass bottle following ingredients were weighed in: 1 g Octanoic acid, followed by 1 g solid polyvinyl pyrrolidone and 7 g Tween 20 (food grade) followed by water to 90 g. The sample was stirred using a magnetic stirrer for a period of 2 hours. The total weight was adjusted to 100 g by addition of water and stiffing was continued until a homogeneous solution was produced. A homogeneous optically clear composition was produced, at pH 3.9, remained stable after storage for 6 months at ambient conditions.

### Example 19

Disinfectant and cleaning composition comprising for Mastitis on cattle: 12.5 g of composition Example 12 was completely miscible with 87.5 g of composition of Example 16. This combination and/or Composition of Example 16 or Composition of example 17 could be used for treatment against mastitis on cattle. These compositions could also be used as a resource material to be applied after dilution to produce disinfecting wipes.

### Example 20

Disinfectant and/or cleaning solid composition made from HP Matrix: Composition of example 16 was freeze dried into a solid which was compacted to a hard tablet. The solid could be used to disinfect in public places and urinals to conserve the use of water.

### Example 21

Disinfectant and/or cleaning solid composition made from LP Matrix: Composition of example 8 was freeze dried into a solid which was compacted to a hard tablet. The solid could be used to disinfect in public places and urinals to conserve the use of water.

### Example 22

Compositions of examples: 4,5, 13,and 14,along with single component A.I compositions: 1,3,12,and 14 were tested for MIC against commonly found bacteria as a function of dilution along with the inert matrices, and produced the following results.

### Example 23

Compositions of Examples 2,Example 4,Example 12,13,and 14 could be mixed with Cetyl Pyridinium Chloride at the therapeutic dose of 0.1%, especially after dilution to the use level.

While this invention has been described in detail with reference to certain preferred embodiments, it should be appreciated that the present invention is not limited to those precise embodiments. Rather, in view of the present disclosure, many modifications and variations would present themselves to those skilled in the art without departing from the scope and spirit of this invention.

What is claimed is:

1. An aqueous, stable, volatile organic compound (VOC)-free microemulsion based antimicrobial disinfectant and/or cleaning concentrate composition capable of inhibiting or killing gram(+), gram(−) and Methicillin-resistant Staphylococcus aureus (MRSA) comprising:
i. a water-soluble matrix composite comprising (a) water-soluble polymer, and (b) water-soluble surfactant;
ii. a blend of antimicrobial agents comprising (a) at least one compound selected from phenols, halogenated phenols, derivatives of phenols, derivatives of halogenated phenols, bis-phenols, cresols, resorcinols, halogenated hydroxyl diphenylethers, anilides or combinations thereof; and (b) at least one compound derived from essential oils; and
iii. optionally, one or more additives.

2. The concentrate composition according to claim 1, where in said composition is stable for at least six months at room temperature or stable for at least 3 freeze/thaw cycles wherein temperature cycled from 50° C. to -24° C. in every 24 hours or stable for at least 2 weeks at about 50° C.

3. The concentrate composition according to claim 1, wherein the water-soluble matrix is a complex of water-soluble polymer and water-soluble surfactant having lower critical micelle concentration (cmc) than a composition without the water-soluble polymer.

4. The concentrate composition according to claim 1, wherein said water-soluble polymer is selected from the group consisting of acid, ester, amide or salts of olefinic polymers, lactam/pyrrolidone based polymers, pyrrolidone co-polymers, α-olefin maleic acid/ester co-polymers, α-olefin polymers, carbohydrate based polymers, and natural polymers or gums alone or in combination.

5. The concentrate composition according to claim 1, wherein said water-soluble surfactant is selected from the group consisting of anionic, non-ionic, amphoteric, and cationic surfactants alone or in combination.

6. The concentrate composition according to claim 5, wherein said water-soluble surfactant is selected from the group consisting of sulfonates, sulfates, phosphates, phosphonates, amine oxides, ammonium carboxylates, ammonium sulfonates, polysorbates, polyalkoxylated alkanols, polyalkoxylated alkylphenols, polyalkoxylated esters, EO/PO copolymers, poloxamers, alkyl polyglucosides, naturally occuring surface active compositions, phospholipids, fatty acid based surfactants, surface active homo or copolymers of polyamines, polyimines, polyalkyleneimines, alkyl/aryl amine alkoxylates, alkyl/aryl/arylalkyl amine oxides and alkoxylated ethylene diamine derivatives alone or in combination.

7. The concentrate composition according to claim 1, wherein said phenol is selected from the group consisting of phenol, 2-methyl phenol, 3-methyl phenol, 4-methyl phenol, 4-ethyl phenol, p-nitrophenol, 2,4-dimethyl phenol, 2,5-dimethyl phenol, 3,4-dimethyl phenol, 2,6-dimethyl phenol, 4-n-propyl phenol, 4-n-butyl phenol, 4-n-amyl phenol, 4-tert-amyl phenol, 4-n-hexyl phenol, 4-n-heptyl phenol, 5-methyl-2-pentylphenol and/or 4-isopropyl-3-methylphenol.

8. The concentrate composition according to claim 1, wherein said halogenated phenol compound is selected from the group consisting of p-chlorophenol, methyl-p-chlorophenol, ethyl-p-chlorophenol, n-propyl p-chlorophenol, n-butyl p-chlorophenol, n-amyl p-chlorophenol, sec-amyl-p-chlorophenol, n-hexyl-p-chlorophenol, cyclohexyl-p-chlorophenol, n-heptyl p-chlorophenol, n-octyl p-chlorophenol, o-chlorophenol, methyl-o-chlorophenol, ethyl-o-chlorophenol, n-propyl o-chlorophenol, n-butyl-o-chlorophenol, n-amyl-o-chlorophenol, tert-amyl-o-chlorophenol, n-hexyl-o-chlorophenol, n-heptyl-o-chlorophenol, o-benzyl-p-chlorophenol, o-benzyl-m-methyl-p-chlorophenol, o-benzyl-m, m-dimethyl-p-chlorophenol, o-phenylethyl p-chlorophenol, o-phenylethyl-m-methyl-p-chlorophenol, 3-methyl-p-chlorophenol, 3,5-dimethyl-p-chlorophenol, 6- ethyl-3-methyl-p-chlorophenol, 6-n-propyl-3-methyl-p-chlorophenol, 6-iso-propyl-3-methyl p-chlorophenol, 2-ethyl- 3,5-dimethyl-p-chlorophenol, 6-sec-butyl- 3-methyl-p-chlorophenol, 2-iso-propyl-3,5-dimethyl p-chlorophenol, 6-diethylmethyl-3-methyl-p-chlorophenol, 6-iso-propyl-2-ethyl-3-methyl p-chlorophenol, 2-sec-amyl-3,5-dimethyl-p-chlorophenol, 2-diethylmethyl-3,5-dimethyl p-chlorophenol, 6-sec-octyl-3-methyl-p-chlorophenol, o-benzylphenol, p-chloro-o-benzylphenol, p-bromophenol, methyl-p-bromophenol, ethyl-p-bromophenol, n-propyl-p-bromophenol, n-butyl-p-bromophenol, n-amyl-p-bromophenol, sec-amyl-p-bromophenol, n-hexyl-p-bromophenol, cyclohexyl-p-bromophenol, o-bromophenol, tert-amyl-o-bromophenol, n-hexyl-o-bromophenol, n-propyl-m, m-dimethyl-o-bromophenol, 2-phenyl phenol, 4-chloro-2-methyl phenol, 4-chloro-3-methyl phenol, 4-chloro-3,5-dimethyl phenol, 2,4-dichloro-3,5-dimethylphenol, 3,4,5, 6-terabromo-2-methylphenol, p-chloro-m-xylenol, chlorothymol and/or 5-chloro-2-hydroxydiphenylmethane.

9. The concentrate composition according to claim 1, wherein said resorcinol compound is selected from the group consisting of resorcinol, methyl resorcinol, ethyl resorcinol, n-propyl resorcinol, n-butyl resorcinol, n-amyl resorcinol, n-hexyl resorcinol, n-heptyl resorcinol, n-octyl resorcinol, n-nonyl resorcinol, phenyl resorcinol, benzyl resorcinol, phenylethyl resorcinol, phenylpropyl resorcinol and/or p-chlorobenzyl resorcinol.

10. The concentrate composition according to claim 1, wherein said halogenated hydroxyl diphenylether is selected from the group consisting of mono or poly halogenated hydroxyl diphenyl ethers.

11. The concentrate composition according to claim 10, wherein said poly halogenated hydroxyl diphenylether compound is selected from the group consisting of 2′,4,4′-trichloro-2-hydroxy-diphenyl ether (triclosan), 3-chloro-2-(2,4-dichlorophenoxy)phenol), 2′,4,4′,5-tetrachloro-2-hydroxydiphenylether, 4,4′,5-trichloro-2-hydroxydiphenylether, 2′,4,4′-trichloro-5-bromo-2-hydroxydiphenylether, 4,4′-dichloro-5-bromo-2-hydroxydiphenylether, 2′, 4,4′-trichloro-2-hydroxydiphenylether, 4,4′-dichloro-2-hydroxydiphenylether, 4,4′-dibromo-2-hydroxydiphenylether, 4′-methyl-4-chloro-2-hydroxydiphenylether, 2′, 4,4′,5′-tetrachloro-2-hydroxydiphenylether, 4,4′-dichloro-3′-trifluoromethyl-2-hydroxydiphenylether, 4,4′-dichloro-3′-methyl-2-hydroxydiphenylether, 4′-methoxy-4-chloro-2-hydroxydiphenylether and/or 4,4′-dichloro-2′-cyano-2-hydroxydiphenylether.

12. The concentrate composition according to claim 1, wherein said essential oil derived compound is selected from the group consisting of menthone, menthyl acetate, neomenthol, piperitone, pulegone, betacaryophyllene, betacaryophyllene-epoxide, alpha-pinene, beta-pinene, germacrene-D, 1,8-cineol, linalool, menthofurane, camphene, beta-hexenyl phenylacetate, d-limonene, 1-limonene, d1-limonene, alpha-citral, beta-citral (geranol), alpha-terpinene, gamma-terpinene, 2-dodecanal, 2-pentenal, cadiene, decylaldehyde, linalool, terpineol, linalyl esters, terpinyl acetate, decanal, C₈ to C₁₀₋₁₂ aldehydes, acids, amyl salicylate, cavacrol, dihydroeugenol, eugenol, hexyl eugenol, hexyl salicylate, isoeugenol, methyl eugenol, methyl isoeugenol, methyl salicylate, tert-butyl cresol, thymol, vanillin, cedrene, cineole, citral, citronellal, citronellol, cymene, paradihydrolinalool, dihydromyrcenol, farnesol, hexyl cinnamaldehyde, hydroxycitronallol, hydroxycitronellal, isocitral, linalool, longifolene, menthol, nerol, nerolidiol, phellendrene, terpinene, tetrahydromyrcenol, carvacrol, dihydroguaiaretic acid, nerolidole, gamma-decalactone and delta-decalactone, monocaprin, monolaurin, cinnamic acid, decanoic acid, 3-hydroxydecanoic acid, 9-decenoic acid, senecionic acid, nonanol, decanol, nonanal, decanal, amyl propionate, anethole, anisic aldehyde, cis-3-hexenol, damascone, ethyl acetoacetate, isoamyl acetate, L-menthol, methyl cinnamate, cyclamen aldehyde, diphenyl oxide, ethyl vanilin, eucalyptol, L-methyl acetate, longifolene, methyl cedryl ketone, methyl chavicol, methyl salicylate, musk ambrette, musk ketone, musk xylol, phenyl ethyl alcohol, vanilin, I-carvone, terpenes, alpha-citronellol, citronellyl acetate, citronellyl nitrile, p-cymene, dihydroanethole, dihydrocarveol, d-dihydrocarvone, dihydrolinalool, dihydromyrcene, dihydromyrcenol, dihydromyrcenyl acetate, dihydroterpineol, dimethyloctanal, dimethyloctanol, dimethyloctanyl acetate, estragole, ethyl-2 methylbutyrate, fenchol, geraniol, geranyl acetate, geranyl nitrile, hexenal, trans-2-hexenol, cis-3-hexenyl isovalerate, cis-3-hexanyl-2-methylbutyrate, hexyl isovalerate, hexyl-2-methylbutyrate, hydroxycitronellal, lonone, isobornyl methylether, linalool oxide, linalyl acetate, menthane hydroperoxide, I-methyl acetate, methyl hexyl ether, methyl-2-methylbutyrate, 2-methylbutyl isovalerate, myrcene, nerol, neryl acetate, 3-octyl acetate, phenyl-ethyl-2-methylbutyrate, cis-pinane, pinane hydroperoxide, pinanol, pine ester, α-pinene oxide, plinol, plinyl acetate, pseudo lonone, rhodinol, rhodinyl acetate, α-terpinene, γ-terpinene, terpinene-4-ol, terpinolene, terpinyl acetate, tetrahydrolinalool, tetrahydrolinalyl acetate, phellandrene, pinene, methylheptenone, safrol, eugenyl acetate, caryophyllene, borneol, bornyl esters, camphor, menthyl esters, safrole, acetaldehyde, chavicol, cinnamyl acetate, α-thujone, β-thujone, and fenchone alone or in combination.

13. The concentrate composition according to claim 1, wherein the blend of antimicrobial agent is present in an amount of about 10 ppm to about 20% by weight of the composition.

14. The concentrate composition according to claim 1, wherein the ratio of said blend of antimicrobial agents (a):(b) is 1:99 to 99:1.

15. The concentrate composition according to claim 1, wherein the effective disinfecting or cleaning concentration of said blend of antimicrobial agents is about 10 ppm to about 5000 ppm.

16. The concentrate composition according to claim 1, wherein said additive is selected from the group consisting of flavors, colors, thickeners, pH adjusting agents, pH buffers including organic and inorganic salts, fragrances, fragrance solubilizers/enhancers, insect-repellants, opacifiers, skin conditioning agents, skin protectants, anti-caking agent, abrasive agent, corrosion inhibitor, defoamer, bleaching agents, anti-spotting agents, anti-oxidants, optical brighteners, hydrotropes, light stabilizers, enzymes, preservatives, and/or sequestering/scale-inhibiting agents.

17. The disinfectant concentrate composition according to claim 1, wherein the water-soluble polymer is polyvinyl pyrrolidone (PVP).

18. The concentrate composition according to claim 17, wherein said polyvinyl pyrrolidone (PVP) is in the range of about 0.01% wt to about 1% wt of the total composition.

19. The concentrate composition according to claim 1, wherein the water-soluble surfactant is sodium lauryl sulfate (SLS).

20. The concentrate composition according to claim 19, wherein the sodium lauryl sulfate is in the range of about 0.1% wt to 5.0% wt.

21. The concentrate composition according to claim 1,further diluted in the weight ratio of from about 1:10 to 1:1000 for end-use applications.

22. The concentrate composition according to claim 1, wherein the weight ratio of antimicrobial agent to water-soluble polymer is about 1:10 to 5:0.5.

23. The concentrate composition according to claim 1, wherein the weight ratio of antimicrobial agent to water-soluble surfactant is about 1:10 to 5:1.

24. The concentrate composition according to claim 1, wherein the weight ratio of water-soluble polymer (a): water-soluble surfactant (b) is about 20:1 to 1:20.

25. An aqueous, stable, volatile organic compound (VOC)-free microemulsion based antimicrobial disinfectant and cleaning concentrate composition effective against gram(+), gram(−) and Methicillin-resistant Staphylococcus aureus (MRSA) comprising:
i. a water-soluble matrix composite made from (a) about 0.10% wt of polyvinyl pyrrolidone (PVP); and (b) about 0.5% wt of sodium lauryl sulfate (SLS);
ii. a blend of (a) about 4.0% wt of triclosan; and (b) about 8.0% wt of thymol; and
iii. optionally, one or more additives.

26. A process for preparing aqueous, stable, volatile organic compound (VOC)-free microemulsion based antimicrobial disinfectant and cleaning concentrate composition comprising the steps of:
i. preparing a mixture of (a) a water-soluble matrix composite and (b) a blend of antimicrobial agents;
ii. dissolving the mixture of step (i) in a suitable aqueous medium; and
iii. incorporating additives if any to the medium resulting from step (ii) and vigorously mixing the composition to result in a stable, aqueous, homogenous, optically clear disinfectant concentrate composition.

27. A method for disinfecting and/or cleaning of hard surfaces where the presence of gram (+), gram (−) and/or Methicillin-resistant Staphylococcus aureus (MRSA) is suspected which comprises the step of:
i. diluting the concentrate composition according to claim 1 in water in a weight ratio of concentrate:water of from 1:10 to 1:1000; and
ii. contacting the hard surface with a disinfecting and/or cleaning effective amount of the concentrate composition.

28. A method for disinfecting or cleaning of hard surfaces where the presence of gram (+), gram (−) and/or Methicillin-resistant Staphylococcus aureus (MRSA) is suspected which comprises the step of:
i. diluting the concentrate composition according to claim 1 in water in a weight ratio of concentrate:water of from 1:10 to 1:1000;
ii. contacting the hard surface with a disinfecting and/or cleaning effective amount of the concentrate composition; and
iii. applying steam of water vapor to enhance the penetration of disinfectant.

29. The concentrate composition according to claim 1 wherein said composition is employed to disinfect and/or clean the hard surfaces, soft surfaces, kitchens, bathrooms, furniture, automobile interiors, textiles, fabrics, carpeting, tiles, walls, floors, chrome, glass, vinyl, plastic, laminated woods, sinks, dishes, sanitary fittings, showers, shower curtains, wash basins, refrigerators, freezers, washing machines, automatic dryers, ovens, microwave ovens, cook-tops, countertops, cabinets, dishwashers, hospitals, hospital beds, clinics, medical centers, pharmaceutical facilities, clean rooms, central service areas, restaurants, hotels, public transport vehicles, public pools, showers, laundries, windshields, fenders, tires, doors, roof, hood, trunk, bumpers, trim, windows, hub caps, transportation body, and/or computers.
